(19) United States
(12) Patent Application Publication
(10) Pub. No.: US 2010/0204920 A1
(43) Pub. Date: Aug. 12, 2010

(54) SYSTEM FOR DEVELOPMENT OF INDIVIDUALISED TREATMENT REGIMENS

(75) Inventors: George Dranitsaris, Toronto (CA); Mark Vincent, London (CA)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: Caduceus Information Systems Inc., Toronto, ON (CA)

(21) Appl. No.: 11/912,660

(22) PCT Filed: Apr. 25, 2006
(86) PCT No.: PCT/CA06/00653

§ 371 Date: Feb. 24, 2010

Related U.S. Application Data
(60) Provisional application No. 60/674,831, filed on Apr. 25, 2005.

(51) Int. Cl. G06F 19/00; G06F 17/18; G06F 15/18

(52) U.S. Cl. 702/19; 706/12; 702/181

(57) ABSTRACT

A system is provided for facilitating the development of an individualised treatment regimen for a patient based on an evaluation of the risk(s) associated with a disease and/or associated with known treatment options. In order to evaluate these risk(s), the system utilises clinical data from a plurality of patients having the disease in question. The clinical data includes information for each of the plurality of patients relating to the presence, absence and/or severity of one or more negative events. The negative event(s) can be disease-related, for example, a complication such as metastasis of a cancer to bone or the brain, or the negative event(s) can be treatment-related, for example a toxicity associated with the treatment. The system can also include prediction models that allow the probability that a patient will develop a toxicity or complication to be assessed. Methods for developing prediction models are provided.

### FIELD OF THE INVENTION

The present invention pertains to the field of healthcare and, in particular, to the development of individualised treatment regimens.

### BACKGROUND

The choice of medical interventions for the treatment of various diseases has expanded considerably in recent years and the treatment options that need to be considered by a patient and their physician have thus also increased. For any treatment, a physician will usually try to estimate the probability of benefit, and the extent of benefit, and, conversely, the probability and extent of harm. Likewise the physician may also try to estimate what complications of the disease might occur and what, if anything can be done to minimize the chance of their occurrence and/or impact, as well as the probability of treatment toxicity and how this can be best managed. The physician needs to convey this information to the patient and family in an understandable form, often in a relatively short period of time, and in a situation in which the patient and family are perhaps emotional and not optimally disposed to process information.

Methods and systems for aiding physicians and/or patients in making decisions regarding treatment have been developed. For example, U.S. Pat. No. 7,027,627 describes a medical decision support system based on data derived from examination of digital images of a tissue specimen according to predetermined criteria for histopathological analysis, and a method for assisting in obtaining a pathological diagnosis from a plurality of pictures representing a specimen on a slide. U.S. Pat. No. 7,010,431 describes a method for effecting computer-implemented decision-support in selection of drug therapy for patients having a viral disease. The method requires the input of patient data including genotype data relating to the viral genome of the viral disease. U.S. Pat. No. 6,317,731 describes a method for predicting the therapeutic outcome of a treatment for a disorder, and specifically for depression, based on patient symptoms.

One of the most prevalent diseases in the developed nations is cancer and a large number of chemotherapeutic options are available to treat and/or manage the disease. Other therapies, such as surgery and radiation, also play a major role in cancer treatment and management. U.S. Patent Application Publication No. 2006/0058966 describes methods and systems for selecting chemotherapeutic agents for treatment of cancer. The method indexes chemotherapeutic agents based on the likelihood that the agent will be useful for a patient or group of patients, and the indexing is based on chemo-sensitivity/resistance assay data. U.S. Patent Application Publication No. 2004/0193019 describes methods for predicting an individual's clinical treatment outcome from sampling a group of patient's biological profiles. The method combines microarray chip analysis of a patient's tissue with discriminant analysis of the patient's proposed treatment plan.

Chemotherapy is a powerful tool in the management and treatment of cancer, however, there are a number of toxicities related to the ongoing use of chemotherapeutics in cancer patients including, for example, nausea, alopecia, neuropathy, neutropenia, thrombocytopenia and anaemia, which can decrease the effectiveness of the chemotherapy, or lead to the need to switch or adjust the chemotherapy regimen. Chemotherapy related toxicities are also a major factor that affects the quality of life of cancer patients.

For example, the occurrence of anaemia is widespread amongst cancer patients. The effects of anaemia, such as fatigue, dizziness, decreased cognitive, sleep and sexual functions, and debilitation, can significantly decrease a patient's quality of life. Recent reports have indicated that anaemia can also have an impact on a patient's overall survival and that treatment of anaemia may have a positive effect on the efficacy of chemotherapy regimens (Gillespie, T. W., Cancer Nurs., 2003, 26:119-128; Ludwig, et al., Eur. J. Cancer, 2004, 40:2293-2306).

Recently, a large-scale survey (the European Cancer Anemia Survey, or ECAS) was conducted to document the prevalence, incidence, evolution, severity and management of anaemia in over 15,000 European cancer patients. The results indicated that two-thirds of cancer patients suffer from anaemia and that only about 40% of these patients receive appropriate treatment (Ludwig, et al., Eur. J. Cancer, 2004, 40:2293-2306). The survey also showed that even mild anaemia (defined as blood haemoglobin levels between 10 and 11.9 g/dL) can affect a patient's quality of life, and oftentimes also impacts treatment outcome.

A number of factors are believed to be involved in the development of anaemia in cancer patients, including the type and extent of chemotherapy and the type and stage of the cancer. Several studies have been conducted to try to identify those factors that indicate that a patient may develop anaemia (for example, Gillespie, T. W., Cancer Nurs., 2003, 26:119-128; Robertson, et al., J. Clin. Oncol., 2004 ASCO Annual Meeting Proc., 22: 14S:9719).

Effective treatments for anaemia exist, including treatment with epoetin alpha and darbepoetin, and the ability to predict the risk of anaemia occurring in cancer patients could, therefore, help to guide appropriate treatment of those patients determined to be at risk of developing anaemia. A few risk-prediction models have been described, for example, Heddens, et al. (Gynecol. Oncol., 2002, 86:239-243) developed a predictive algorithm for likelihood of red blood cell transfusion in women with ovarian cancer undergoing platinum-based chemotherapy, with the aim of identifying patients should be considered for prophylactic erythropoietin therapy. Similarly, Ludwig, et al. (Program and abstracts of the 46^{th} Annual Meeting of the American Society of Hematology, Dec. 4-7, 2004, Abstract 3133) developed an anaemia risk model for lymphoma/multiple myeloma patients to help identify disease characteristics that predict anaemia during chemotherapy and to evaluate timing for anaemia development. This latter study, however, used the entire data from the ECAS survey (i.e. encompassing all cancers), which would likely weaken the predictive ability of the model due to the introduction of heterogeneity. In addition, the methods by which the above models were developed are not generally applicable to other types of cancer or other chemotherapy-related toxicities.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system for the development of individualised treatment regimens. In accordance with one aspect of the present invention, there is provided a system for facilitating development of an individualised treatment regimen for a patient having a disease in need of treatment, said system comprising
one or more databases comprising clinical data from a plurality of patients having said disease, said clinical data including event data representative of the presence, absence and/or severity of one or more negative events;
processing means operatively associated with said database and configured for analysing said clinical data to generate an output containing negative event evaluation data;
input means for inputting data into said system, and
output means for outputting data from said system;
wherein said negative event evaluation data facilitates the development of said individualised treatment regimen.

In accordance with another aspect of the present invention, there is provided a method for facilitating the development of an individualised treatment regimen for a patient having a disease in need of treatment, said method comprising
assembling clinical data from a plurality of patients having said disease, said clinical data including event data representative of the presence, absence and/or severity of one or more negative events, and
analysing said clinical data to generate an output containing negative event evaluation data;
wherein said negative event evaluation data facilitates the development of said individualised treatment regimen.

In accordance with another aspect of the present invention, there is provided a method for developing a negative event prediction model, said method comprising the steps of:
(i) assembling clinical data representing a patient population having a disease of interest, said clinical data including event data relating to the presence, absence and/or severity of one or more negative events, wherein said patient population includes at least 50 occurrences of said one or more negative events;
(ii) classifying the clinical data into classified data defining a plurality of potential risk factors;
(iii) processing the classified data to identify initial risk factors and selecting secondary data comprising the initial risk factors;
(iv) subjecting the secondary data to a first analysis to generate a general system based on the initial risk factors, and
(v) subjecting the general system to a second analysis to identify primary risk factors and thereby generate a negative event prediction model based on the primary risk factors.

In accordance with another aspect of the present invention, there is provided a system for predicting the probability that a patient having a disease will experience a negative event, said system comprising
one or more databases comprising clinical data from a plurality of patients having said disease, said clinical data including event data relating to the presence, absence and/or severity of one or more negative events;
input means for inputting patient data relating to said patient having the disease into said system;
processing means operatively associated with said database and configured for executing a negative event prediction model produced by the method of any one of claims 20, 21, 22, 23, 24, 25 or 26 to generate an output containing a negative event prediction value, and output means for outputting data from said system.

In accordance with another aspect of the present invention, there is provided an apparatus for facilitating the development of an individualised treatment regimen for a patient having a disease in need of treatment, said apparatus comprising
means for analysing clinical data from a plurality of patients having said disease, said clinical data including event data representative of the presence, absence and/or severity of one or more negative events, and
means for generating an output based on said step of analysing, said output containing negative event evaluation data;
wherein said negative event evaluation data facilitates the development of said individualised treatment regimen.

In accordance with another aspect of the present invention, there is provided a computer program product comprising a computer readable medium having a computer program recorded thereon which, when executed by a computer processor, cause the processor to execute a method for facilitating the development of an individualised treatment regimen for a patient having a disease in need of treatment, said method comprising
analysing clinical data from a plurality of patients having said disease, said clinical data including event data representative of the presence, absence and/or severity of one or more negative events, and
generating an output based on said step of analysing, said output containing negative event evaluation data;
   wherein said negative event evaluation data facilitates the development of said individualised treatment regimen.

In accordance with another aspect of the present invention, there is provided a computer program product comprising a computer readable medium having a computer program recorded thereon which, when executed by a computer processor, cause the processor to execute a method for developing a negative event prediction model, said method comprising
(i) classifying clinical data into classified data defining a plurality of potential risk factors, wherein said clinical data represents a patient population having a disease of interest, said clinical data including event data relating to the presence, absence and/or severity of one or more negative events, wherein said patient population includes at least 50 occurrences of said one or more negative events;
(ii) processing the classified data to identify initial risk factors and selecting secondary data comprising the initial risk factors;
(iii) subjecting the secondary data to a first analysis to generate a general system based on the initial risk factors, and
(iv) subjecting the general system to a second analysis to identify primary risk factors and thereby generate a negative event prediction model based on the primary risk factors.

### BRIEF DESCRIPTION OF THE FIGURES

These and other features of the invention will become more apparent in the following detailed description in which reference is made to the appended drawings.

FIG. 1 presents a graphical output in one embodiment of the present invention that relates cumulative toxicities of various treatment options to efficacy.

FIG. 2 presents a graphical output in another embodiment of the present invention that relates cumulative toxicities of various treatment options to efficacy and includes the superimposition of a Cartesian plane.

FIG. 3 presents a graphical output in another embodiment of the present invention that relates cumulative toxicities of various treatment options to efficacy and includes the superimposition of a Cartesian plane and an iso-indicative line.

FIG. 4 presents a graphical output in another embodiment of the present invention that relates cumulative toxicities of various treatment options to efficacy and includes user defined thresholds for maximal toxicity and minimum efficacy.

FIG. 5 presents a graphical output in another embodiment of the present invention that relates cumulative toxicities of various treatment options to efficacy and includes a breakdown of the contributions of individual toxicities to the cumulative total.

FIG. 6 presents a graphical output in another embodiment of the present invention that relates cumulative toxicities of various treatment options to efficacy and demonstrates the expected shift in position of each plotted point when a toxicity is subtracted from the cumulative total.

FIG. 7 presents a graphical output in another embodiment of the present invention that relates cumulative toxicities of various treatment options to efficacy and demonstrates the expected shift in position of each plotted point after application of a predictive model that individualises the risks and benefits associated with each treatment option for a particular patient.

FIG. 8 presents an example of a Welcome page for a web-based portal in one embodiment of the present invention.

FIG. 9 presents an example of a news service feature for a web-based portal in one embodiment of the present invention.

FIG. 10 presents an example of a log-in page for a web-based portal in one embodiment of the present invention.

FIG. 11 presents an example of a disease selection page for a web-based portal in one embodiment of the present invention.

FIG. 12 presents an example of an event selection page for a web-based portal in one embodiment of the present invention.

FIG. 13 presents an example of an event calculation page for a web-based portal in one embodiment of the present invention.

FIG. 14 presents an example of a output page for a web-based portal in one embodiment of the present invention showing the probability that a patient will experience a toxicity.

FIG. 15 presents a graphical representation of the correlation between patient risk score and probability of anaemia for patients with breast cancer.

FIG. 16 presents a graphical representation of the correlation between patient risk score and probability of anaemia for patients with advanced non-small cell lung cancer.

FIG. 17 presents (A) a plot of overall survival against toxicity sum and (B) a plot of progression survival against toxicity sum for first line treatment of metastatic colorectal cancer.

FIG. 18 presents (A) a plot of overall survival against trial accrual midpoint date and (B) a plot of progression free survival against trial accrual midpoint date for first line treatment of metastatic colorectal cancer.

### DETAILED DESCRIPTION OF THE INVENTION

The present invention provides a system for facilitating the development of an individualised treatment regimen for a patient based on an evaluation of the risk(s) associated with a disease and/or associated with known treatment options. In order to evaluate these risk(s), the system utilises clinical data from a plurality of patients having the disease in question. The clinical data includes information for each of the plurality of patients relating to the presence, absence and/or severity of one or more negative events. The negative event(s) can be disease-related, for example, a complication such as metastasis of a cancer to bone or the brain, or the negative event(s) can be treatment-related, for example a toxicity associated with the treatment. The negative event data can be, for example, composite data indicating the presence, absence and/or severity of all negative events experienced by the plurality of patients, or it can be data relating to a single negative event (such as a negative event that is of particular concern for the patient or physician) or a selection of negative events of interest to the physician/patient. In general, each of the plurality of patients has undergone at least one treatment option and, in one embodiment of the present invention, the clinical data further comprises benefit data relating to the benefit each of the plurality of patients derived from the treatment option, for example, the benefit data can indicate overall survival time, progression-free survival time, and the like.

The system provides for analysis of the clinical data to provide an indication of the risk/benefit ratio (or “therapeutic index”) associated with each treatment option and/or an indication of the probability that the individual patient under assessment will experience one or more of the negative events associated with a treatment option and/or disease.

The system can be used as part of a physician/patient consultation in order to evaluate potential treatment options for the patient in terms of relative benefits and risks associated with each available option. The patient can be presented with a comparison of the therapeutic indices of competing treatment options, for example, by means of a graphical display. The system further provides for an indication of the uncertainty around each therapeutic index.

The system can also include prediction models that allow the probability that a patient will develop a toxicity or complication to be assessed, as noted above. The prediction models can be employed as part of the evaluation of the potential treatment options to provide a comparison of the individualised therapeutic indices of competing treatment options and/or an individualised probability that the patient will experience one or more of the risk(s) associated with the disease or treatment. Thus the system allows a comparison of competing treatment options to be made “patient specific” through the input of particular characteristics of the patient into a prediction model. Similarly, through the use of a prediction model, the system can provide a numerical indication, such as a percentage, that the patient will experience a particular risk associated with the disease or treatment.

The system also provides for the “weighting” of certain toxicities according to the patient's fears or preferences, and/or the medical professional's assessment of the vulnerability of the patient to a particular toxicity and/or the need to avoid a particular toxicity/toxicities. Similarly, the system allows for the subtraction of a particular toxicity or toxicities from the comparison on the assumption that an effective strategy will be put in place to prevent and/or manage its occurrence, thus providing an indication of the residual toxicities for which such prevention or management will not be available. Thus, the system can be used to determine which treatment options that initially appear unacceptable due to a high individual toxicity risk can be made acceptable by employing a supportive medication, for example G-CSF for neutropenia, to remove a particular toxicity.

Thus, in one embodiment, the system of the present invention provides information to physicians and patients relating to both efficacy and risks associated with a treatment option or options in a timely manner, allowing for pre-emptive action and/or better go/no-go treatment decisions and the development of an individualised treatment regimen for the patient that takes into account the patient's personal susceptibilities and preferences.

The system allows for pro-active steps to be taken towards the elimination, minimisation or management of toxicities associated with a particular treatment option or complications associated with a disease such as, for example, implementation of appropriate supportive care, initiation of adjunctive therapy, forewarning of the patient, initiation of intensive early-monitoring schemes or action plans for early intervention.

The system further provides for a means to adapt and change the predictive models and/or comparisons on an ongoing basis by storing patient data and selected treatment options in a database, and by allowing ongoing input of patient outcome data, which can be used for continuous improvement of the prediction models.

The present invention further contemplates that the system can comprise a web-based portal for access to the system over the internet. Alternatively, the system can be made available as a computer program product that can be provided or downloaded for local use.

The present invention further provides for a method for developing prediction models for inclusion in the system described above. The prediction models allow for the prediction of the likelihood that a patient will experience a negative event related to a disease the patient has, or related to the treatment the patient is currently undergoing or about to undergo.

### DEFINITIONS

Unless defined otherwise, all technical and scientific terms used herein have the same meaning as commonly understood by one of ordinary skill in the art to which this invention pertains.

The terms “therapy” and “treatment,” as used interchangeably herein, refer to an intervention performed with the intention of improving a patient's status. The terms thus encompass drug therapy (or chemotherapy), radiation therapy, non-conventional therapies, and combinations thereof.

As used herein, the term “about” refers to a +/−10% variation from the nominal value. It is to be understood that such a variation is always included in any given value provided herein, whether or not it is specifically referred to.

### System for Facilitating Development of Individualised Treatment Regimens

For convenience, in the detailed description provided below, the invention is described primarily with reference to a particular embodiment, i.e. the treatment of cancer. It is to be understood, however, that the system is generally applicable to other diseases and conditions that have associated complications and/or treatment options to which a therapeutic index is applicable (i.e. treatment options which have associated therewith at least one benefit and at least one side-effect).

As noted above, the system according to the present invention utilises clinical data to provide an evaluation of the risk(s) associated with a disease or associated with known treatment options for an individual patient. In general, the system comprises a processing means and one or more databases comprising the clinical data, the processing means being operable to analyse the clinical data to provide an output that contains information relating to the risk(s) associated with the disease or treatment options and which facilitates the development of said individualised treatment regimen.

In one embodiment of the present invention, the system further comprises one or more prediction models that can be executed by the processing means to provide a probability that a patient will develop a toxicity or complication to be assessed.

### Processing Means

The processing means comprised by the system of the present invention is capable of implementing analysis of the clinical data and provide outputs as described below. In one embodiment, the processing means is also capable of executing one or more prediction models. It is to be understood that the processing means can be provided as hardware, software, firmware, special purpose processors, or a combination thereof. The software can be implemented, for example, as an application program tangibly embodied on a program storage device. The application program can be uploaded to, and executed by, a machine comprising any suitable architecture. The machine can be implemented on a computer platform having hardware such as one or more central processing units (CPU), a random access memory (RAM), and input/output (I/O) interface(s). The computer platform can also include an operating system and microinstruction code. The processing means can be part of the microinstruction code or part of the application program (or a combination thereof) which is executed via the operating system. In addition, various other peripheral devices may be connected to the computer platform such as an additional data storage device, such as disk and/or optical storage, printing devices, network/communications devices, and the like. The system can also be delivered as a software program through a hand held devise (e.g Palm Pilot®).

### Clinical Data

The clinical data for the system of the present invention is assembled from patients having the disease of interest, i.e. the “patient population,” and includes information relating to the presence, absence and/or severity of one or more negative events, such as complications or toxicities, for each of the patients. The clinical data can be obtained from the scientific literature, from existing databases, from clinical trials and/or directed chart review.

In order to provide suitable clinical data for purposes of the present invention, the patient population should include at least about 30 occurrences of the negative event or events in question. In one embodiment, the patient population should include at least about 40 occurrences of the negative event or events in question. In another embodiment, the patient population should include at least about 50 occurrences of the negative event or events in question.

Accordingly, the selected patient population will comprise a minimum of at least about 50 patients. Typically the patient population comprises about 100 patients. In one embodiment, the patient population comprises at least about 200 patients. In another embodiment, the patient population comprises at least about 250 patients.

The upper limit for the size of the patient population is not subject to defined limits, however, it is generally selected according to the data-handling capabilities of the user. In one embodiment, an upper limit of up to about 20,000 patients is contemplated. Although it will be readily apparent to one skilled in the art that larger patient populations can also be used.

In one embodiment of the present invention, the patient population comprises between about 100 and about 10,000 patients. In another embodiment, the patient population comprises between about 200 and about 8,000 patients. In a further embodiment, the patient population comprises between about 200 and about 6,000 patients. In another embodiment, the patient population comprises between about 200 and about 4,000 patients. In other embodiments, the patient population comprises between about 200 and about 3,000 patients, between about 200 and about 2,500 patients, between about 200 and about 2,000 patients, between about 200 and about 1,500 patients, between about 200 and about 1,500 patients, between about 200 and about 1,000 patients, between about 200 and about 800 patients and between about 200 and about 600 patients.

In one embodiment of the present invention, the patient population is selected from an existing database, for example, from the European Cancer Anaemia Survey (ECAS) database (see Ludwig, et al., Eur. J. Cancer, 2004, 40:2293-2306). In another embodiment of the present invention, the clinical data is obtained from the scientific literature.

### Diseases

As indicated above, the system of the present invention is readily applicable to a variety of diseases or conditions having associated complications and/or treatment options to which a therapeutic index is applicable. Examples include, cancer, viral infections, infectious diseases, autoimmune diseases, cardiovascular diseases and neuropsychiatric conditions.

With respect to the embodiment of the present invention relating to cancer, the system can be applied to a variety of cancers. Examples include, but are not limited to, acute lymphocytic leukaemia, adrenal cancer, breast cancer, cancer of the central nervous system, cervical cancer, chronic lymphocytic leukaemia, chronic myelogenous leukaemia, colon cancer, colorectal cancer, endometrial cancer, oesophageal cancer, genitourinary tract cancer, gliomas, head and neck cancer, Hodgkin's disease, Kaposi's sarcoma, kidney cancer, laryngeal cancer, leukaemia, lung cancer, lymphoma, medulloblastoma, mesothelioma, multiple myeloma, neuroblastoma, non-Hodgkin's lymphoma, non-small cell lung cancer, ovarian cancer, pancreatic cancer, prostate cancer, rhabdomyosarcoma, small cell lung cancer, stomach cancer, testicular cancer, thyroid cancer, urinary bladder cancer and uterine cancer.

The system can be applied to all cancers of a certain type, or to a type of cancer at a certain stage, for example, an adjuvant situation, a neoadjuvant situation, or a situation involving a metastatic cancer, an advanced cancer, a drug resistant cancer, a hormone-resistant cancer, or the like. An “adjuvant situation” refers to a cancer that has been operated on with the intent of curative resection, but where there may be some risk of recurrence as defined for example by microscopic features evident to the pathologist (for example, lymph node positivity). Accordingly, an adjuvant situation is where the cancer has been resected where there is some risk of recurrence and, therefore, the patient is eligible for some postoperative therapy (such as chemotherapy, hormone therapy or radiotherapy), which may cause a toxic event.

A neoadjuvant situation is one where the chemotherapy is administered prior to definitive surgery with the intention of shrinking the cancer so that a lesser degree of surgery can be carried out. “Advanced cancer,” refers to overt disease in a patient, wherein such overt disease is not amenable to cure by local modalities of treatment, such as surgery or radiotherapy. Advanced disease may refer to a locally advanced cancer or it may refer to metastatic cancer. The term “metastatic cancer” refers to cancer that has spread from one part of the body to another. Advanced cancers may also be unresectable, that is, they have spread to surrounding tissue and cannot be surgically removed.

The system can also be applied to a specific group of cancers, such as, male urogenital cancer (including prostate, bladder, testicular and kidney cancer), gynaecological cancer (cervical, ovarian and uterine), haematological cancers, or gastrointestinal/colorectal cancers.

### Negative Events

The clinical data includes information for each of the plurality of patients that relates to the presence, absence and/or severity of one or more negative events. The negative event(s) can be disease-related or treatment-related.

Disease-related negative events include complications associated with the disease, such as, bone metastasis associated with breast cancer, brain metastasis associated with lung cancer, intestinal obstruction, perforation or bleeding associated with bowel cancer, and venous or thromboembolic events associated with pancreatic cancer.

Treatment-related negative events are generally toxicities (or “toxic events”) associated with the treatment the patient is undergoing. With specific reference to cancer, examples of such toxic events include, but are not limited to, neutropenia, thrombocytopenia, anaemia, nausea, vomiting, diarrhoea, stomatitis, alopecia, peripheral neuropathy, renal impairment, venous thrombolic events, skin toxicity, allergic reactions, pneumonitis, cardiac toxicity (e.g. congestive heart failure) and oesophagitis.

For disease-related negative events, the presence or absence of the event (complication) can be readily determined. For treatment-related negative events, such as treatment-related toxicities, in general a yes/no (i.e. present/absent) designation is assigned based on a “quantifiable characteristic” of the negative event and a pre-set cut-off value. The “quantifiable characteristic” can be evaluated through measurement, or it can be evaluated by comparing the severity of a characteristic with a standard scale and then according a “grade” to the negative event. For example, when the treatment-related toxic event is anaemia, haemoglobin levels can be measured; when the toxic event is neutropenia, neutrophil cell counts can be evaluated; for the toxic event thrombocytopenia, platelet counts can be evaluated. For other chemotherapy related toxic events, such as nausea, fever and the like, the severity of the event can be graded. Establishing grades for such toxic events is common clinical practice and is frequently used as an evaluation of the severity of side effects during clinical trials. Quantifiable characteristics that provide an indication of the presence or absence of other toxic events are known in the art.

### Treatment Options

In accordance with one embodiment of the present invention, each patient in the patient population from which the clinical data is derived has undergone at least one treatment option. The treatment option can be a drug therapy, radiation therapy, surgery, or the like, or it can be biological therapy, such as immunotherapy, gene therapy or antisense therapy. Combinations of therapies, for example, concurrent radiation and chemotherapy for cancer, are also encompassed.

### Benefit Data

In one embodiment of the present invention, the clinical data further comprises benefit data relating to the benefit each of the plurality of patients derived from a treatment option. Benefit data can relate to, for example, overall survival (OS); progression free survival (PFS); objective response rate (CR+PR); disease control rate (CR+PR+SD), i.e. the non-PD rate; symptom control rate; quality of life scores; time to PS deterioration; weight; maintenance or restoration of functionality and/or independence.

Best Supportive Care (BSC) also has some survival value (and zero toxicity). In one embodiment of the present invention, therefore, the benefit data relates the benefit achieved over and above the benefit to be expected with BSC, for example, the OS achievable with the treatment option over and above the OS to be expected with BSC.

### Analysis and Output

In accordance with the present invention, the system analyses the clinical data to provide an output that contains information relating to the risk(s) associated with the disease or treatment options and which facilitates the development of an individualised treatment regimen for the patient being assessed. The analysis of the clinical data may be simple or complex depending on the output desired by the user. With the exception of the predictive models, which are described in more detail below, standard analysis methods can be employed by the processing means to generate the outputs described below.

For example, in one embodiment of the present invention, the clinical data comprises data derived from a patient population having the disease of interest, each patient having undergone at least one treatment option. For the purposes of assembling clinical data for this embodiment, when there are several reports or trials describing the same treatment option, the values are averaged. The analysis comprises deriving a cumulative toxicity associated with each treatment regimen and plotting this against the average benefit (for example, overall survival) associated with the treatment option. By “cumulative” is meant the proportions of patients developing each toxicity, rather than the total number of episodes. A non-limiting examples of this type of analysis is provided herein as Example 3.

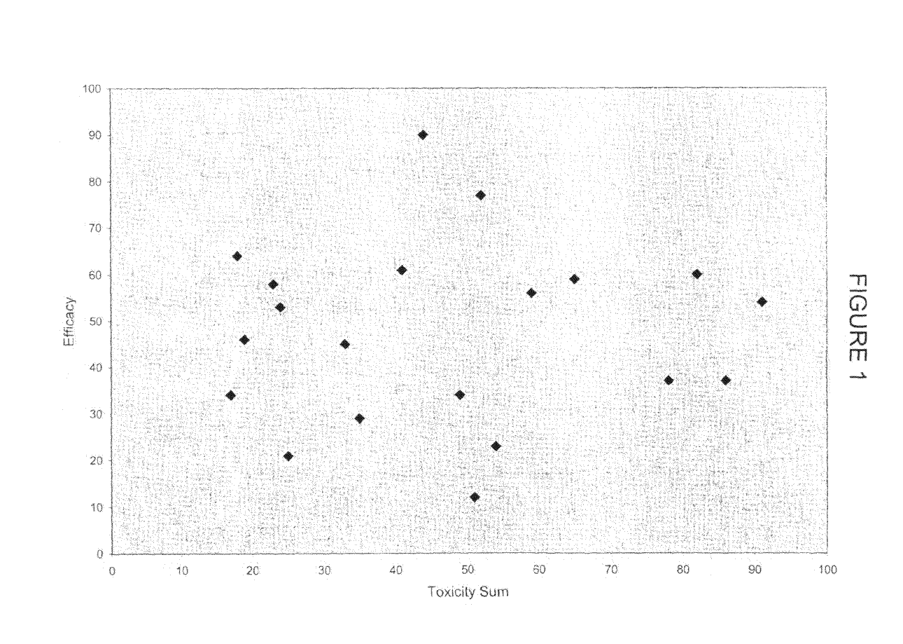

The output for this embodiment therefore can be a graphical representation of cumulative toxicity vs. efficacy, such as that shown in FIG. 1.

In another embodiment, a confidence interval can be calculated for each point on the graph. The confidence interval is a reflection of the sample size and the certainty that can be attributed to the values calculated for each point. The confidence interval can be represented, for example, by a box around each point or by error bars.

In another embodiment of the present invention, the above analysis can further comprise determining the survival gain per unit of toxicity (risk) by connecting each plotted point (representing a treatment option) by a straight line to the origin. The line can also be extrapolated away from the origin. The slope

$$\frac{Δ y}{Δ x}$$

of the line represents the same therapeutic index for all points on the line and represents a survival gain per unit of toxicity (risk). A low benefit/low toxicity treatment option will have the same therapeutic index as a high benefit/high toxicity treatment option.

This embodiment further provides for the comparison of two treatment options by constructing a line between two points representing each treatment option of interest. The slope of this additional line can be calculated from the coordinates

$$( slope = \frac{{y}_{1} - {y}_{2}}{{x}_{1} - {x}_{2}} )$$

and represents the rate of gain (loss) of survival per unit of weighted toxicity risk, and provides a visual means of choosing between treatment options.

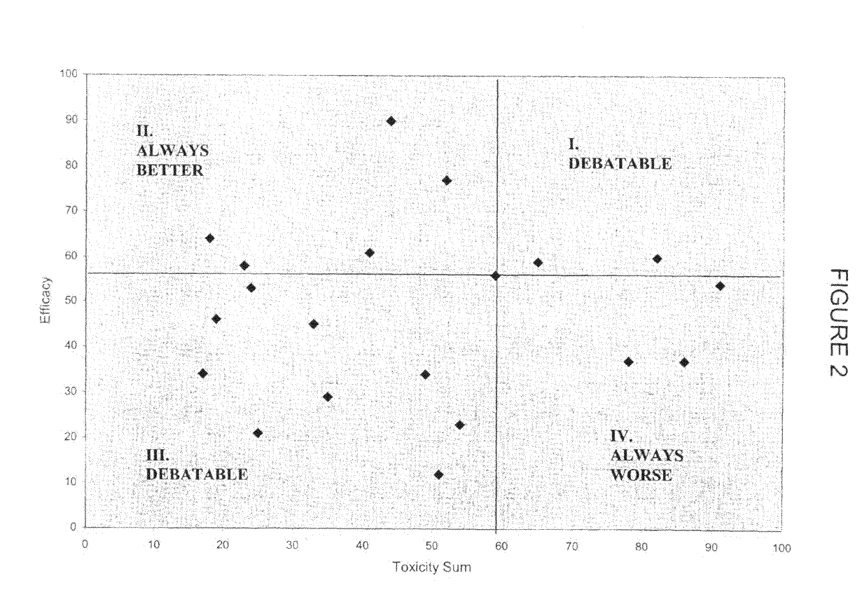

In a further embodiment of the present invention, a Cartesian plane is superimposed on the graph described above as shown generally in FIG. 2. The origin of the Cartesian plane is the point representing one treatment option, for example, the standard treatment option for the disease of interest. As is known in the art, Cartesian planes can be divided into 4 quadrants, I, II, III and IV, as shown in FIG. 2. This representation allows for a simple comparison between treatment options. For example, if the origin of the Cartesian plane represents the standard treatment, any treatment that falls within quadrant II, represents treatment with lower toxicity and greater efficacy, i.e. “a better choice” than standard treatment. A treatment in quadrant IV, on the other hand, represents an inferior choice having a greater toxicity and lower efficacy than standard treatment. Treatments that fall within quadrant I have a greater efficacy, but also a greater toxicity, whereas those in quadrant III have a lower toxicity, but also a lower efficacy relative to standard treatment.

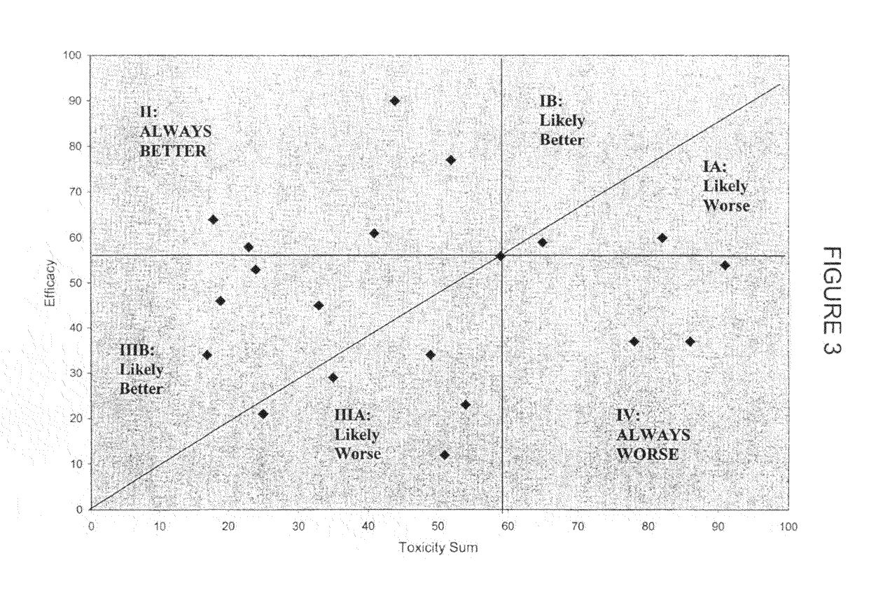

In a further embodiment, the analysis can further comprise providing an ‘iso-index’ line that connects the treatment option at the origin of the Cartesian plane with the origin of the main graph. This iso-index (or ‘iso-indicative’) line divides quadrants I and M into IA and IB, and MA and MB, respectively, as shown in FIG. 3. This representation can facilitate a decision regarding a treatment option that falls in quadrant I or III. For example, a treatment option that falls in IB may be strongly considered. Although the toxicity is greater for this treatment, it may be superior to the standard treatment, as the increase in toxicity is minor compared to the gain in efficacy. Similarly for a treatment option in MB, the efficacy is lower than the standard treatment, but so is the toxicity and as such, this treatment option may also be considered. Treatment options in IB or MA are likely inferior to the standard treatment.

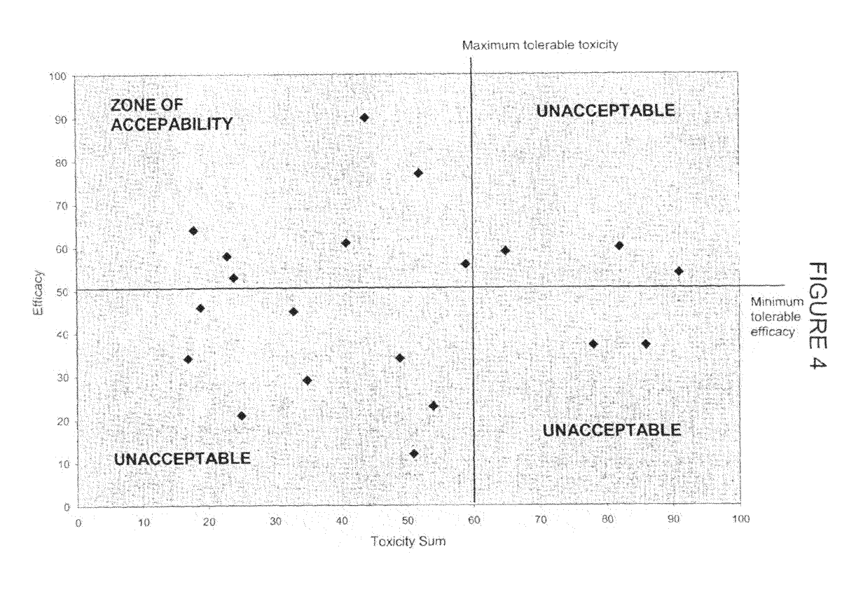

In another embodiment of the present invention, the analysis can comprise the implementation of toxicity limits, for example, representing a tolerance level of the patient based on personal criteria or the physician's assessment of the vulnerability of the patient. The tolerance limits can be represented in a graphical output, for example, as a straight vertical line, as shown in FIG. 4. Any treatment option that falls to the right of this line represents an unacceptable option. Likewise, a minimum survival gain can be included and represented by a horizontal line as shown in FIG. 4. All treatment options that fall below this line would represent unacceptable options. It can thus be rapidly appreciated which treatment options are viable, i.e. those falling within the “zone of acceptability.”

In a further embodiment of the present invention, the analysis further comprises a step in which each of the negative events are attributed a weighting based on, for example, the patient's fear or vulnerability considerations or based on the severity of the consequences should a negative event actually occur.

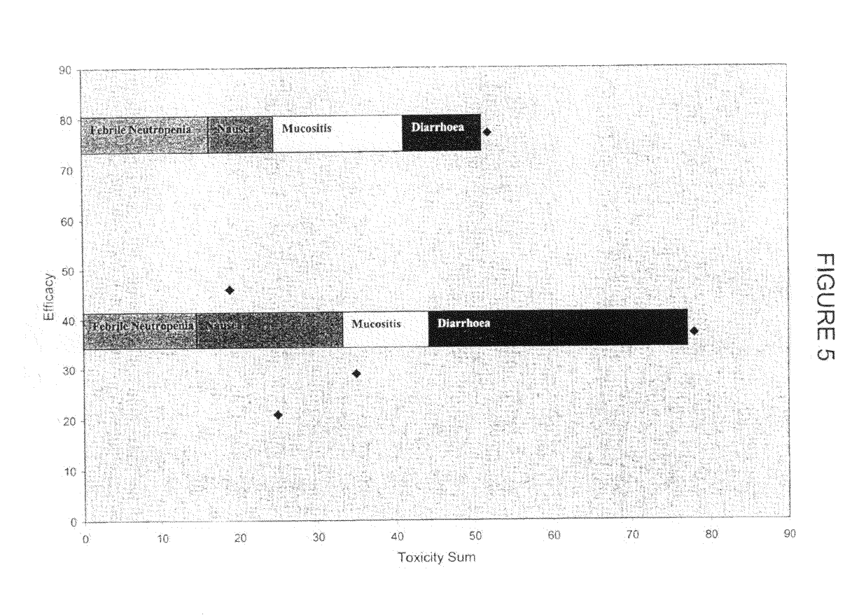

In another embodiment, the analysis further comprises a breakdown of the toxicities that comprise the cumulative value shown on the graphical output. The breakdown can be included in the output, for example as shown in FIG. 5, so that the amount each individual toxicity contributes to the total can be readily visualised.

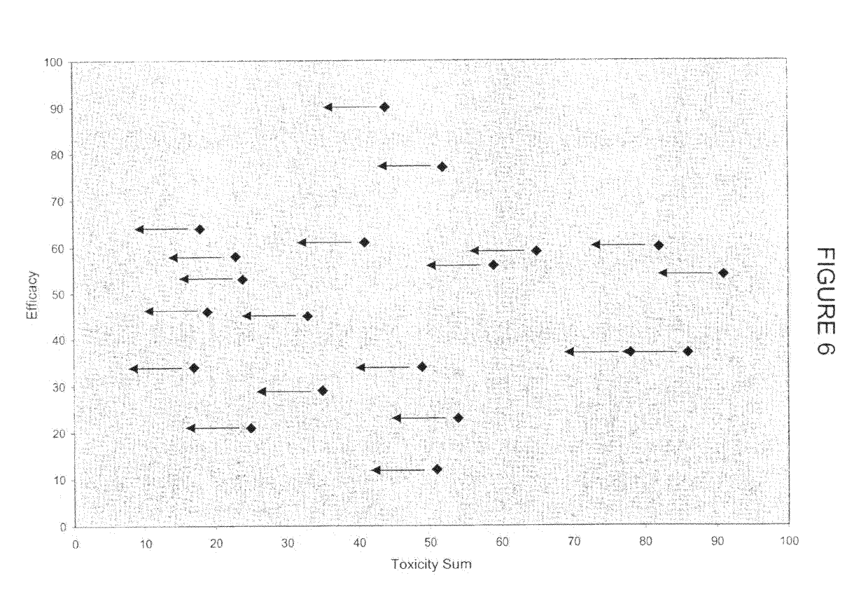

In another embodiment, the analysis includes a step in which an individual toxicity can be removed from the overall analysis and the output adjusted accordingly. For example, if a toxicity can be readily managed or prevented, then it can be subtracted from the cumulative toxicities and the output would thus represent the residual toxicities for which such prevention or management will not be available. By way of example, a toxicity associated with certain chemotherapies is febrile neutropenia, which can be effectively prevented by treatment with G-CSF. Accordingly, the febrile neutropenia component could be eliminated from the analysis and the relevant points on the graphical output would move to the left, as shown in FIG. 6, to represent the lower cumulative toxicity in the absence of febrile neutropenia.

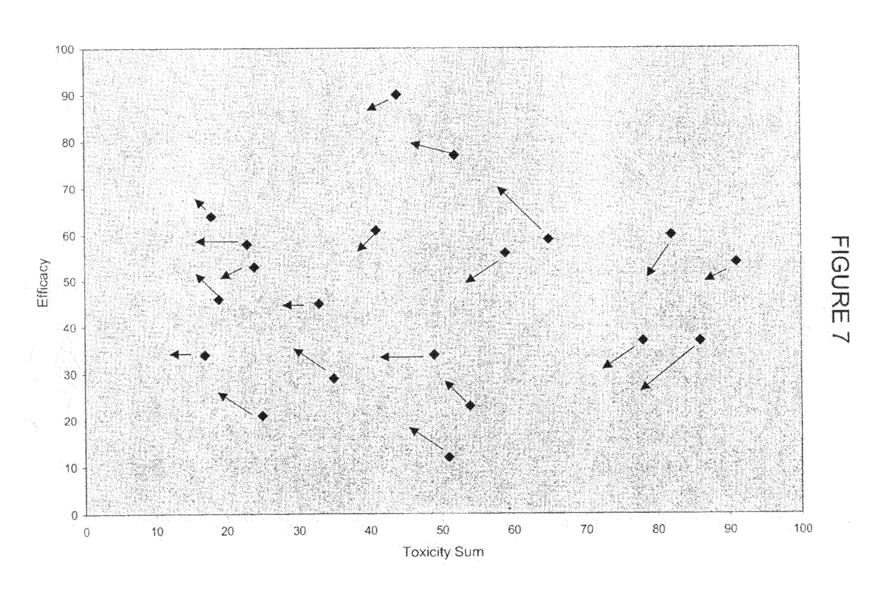

In another embodiment, the analysis includes the use of a prediction model that allows the probability that the individual patient being assessed will develop a toxicity or complication to be calculated. The prediction models can be developed using the method described in detail below. When the comparison is provided as a graphical display, the application of the prediction model will shift each of the plotted treatment options from its original point (derived from the published clinical data), to a new point defining the individual patient's risk/benefit, this is shown schematically in FIG. 7. Additional analysis steps, including those described above can be applied to the individualised risk/benefit outputs.

In an alternative embodiment of the present invention, the clinical data comprises data relating to the same negative event derived from a patient population having the disease of interest, each patient having undergone at least one treatment option. The data can be analysed by applying a prediction model relating to the negative event to provide an output that comprises an individualised risk factor as a numerical indication, such as a probability coefficient or percentage, indicating the likelihood that the patient will experience the negative event.

Other embodiments contemplated by the present invention include incorporation of the relative costs of treatment options into the analysis and an output that allows the cost associated with each option to be visualised, such as a 3-dimensional graph.

### Web-Based Systems

The present invention further contemplates that the system can comprise a web-based portal for access to the system over the internet from a remote location. As such, the system can comprise application programs that provide configurable menus, business logic, database schema and the like. The portal can provide unrestricted access to the system or it can provide restricted access requiring a user to log in, for example, with a user name and password. Access to the portal may require the payment of fee or a subscription.

The present invention also contemplates that different levels of access to the portal can be provided, the different access levels providing different levels of sophistication with respect to the application programs and display options that are available. For example, the access levels can be based on the educational level or sophistication of the particular audience, i.e. patients, their families, medical students, residents in training, nurses, and the like. For example, one level of access can be provided to patients, another to healthcare providers, and a third to physicians.

The portal could further comprise notification of sponsors and/or advertisements. For example, when an output is provided by the system, it can be associated with the selection and highlighting of individual sponsor's products that are relevant to the situation and specific negative event(s) being identified. Advertisements included in the web-pages of the web-based system can be targeted, as the type of potential users of the system is known.

The web-based system generally comprises a front-end Web Server containing the application programs and business logic, and a back-end database management system comprising applications for performing calculations, providing output to users (e.g. graphs), capturing user inputs, and the like.

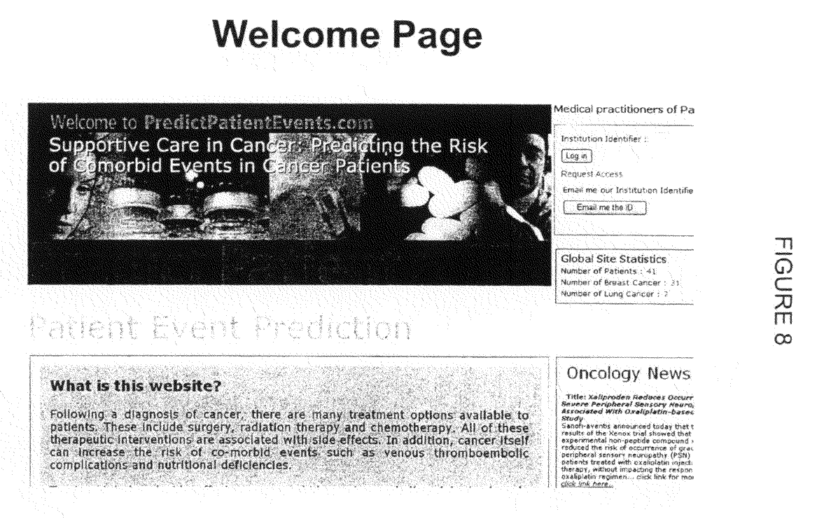

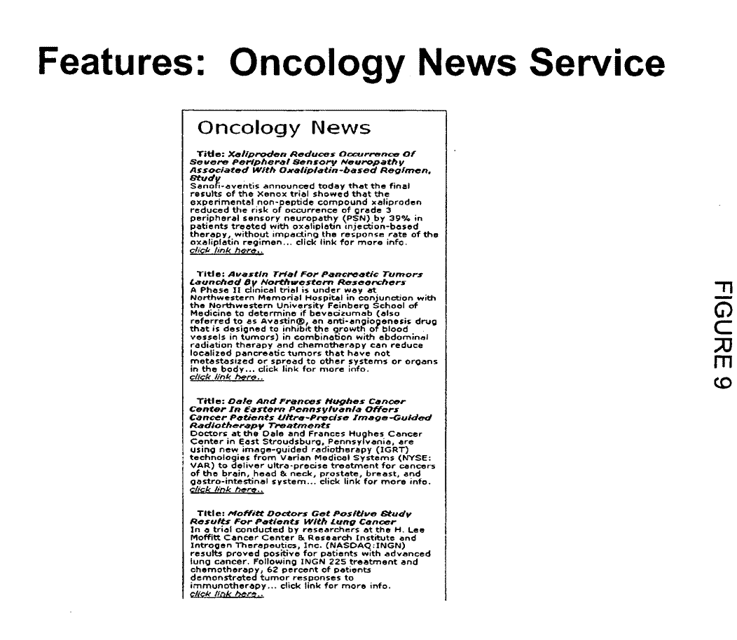

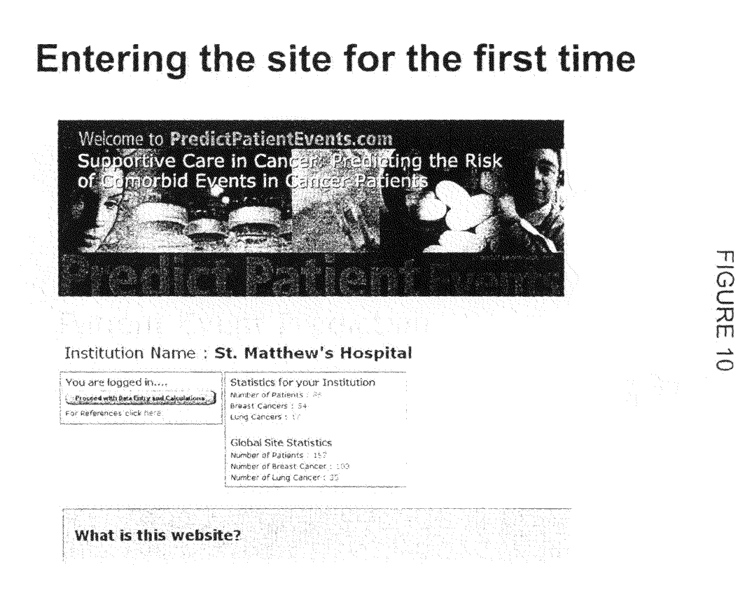

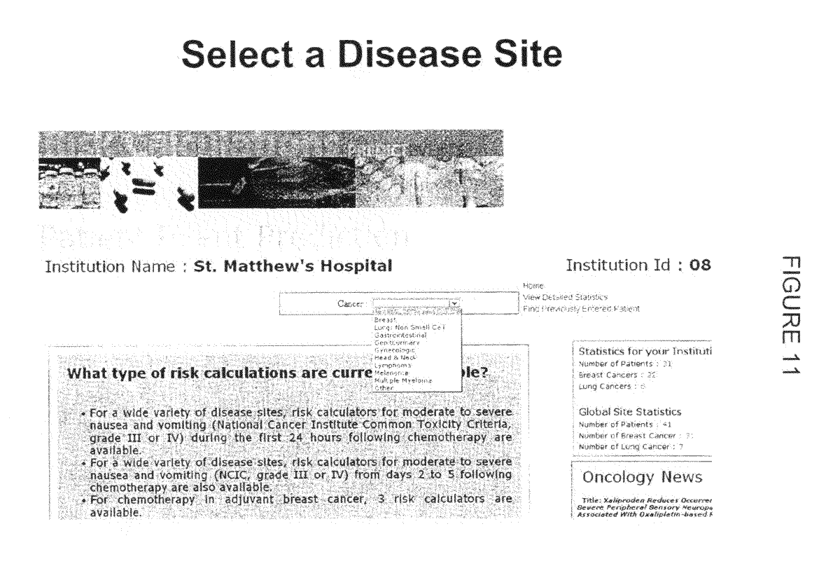

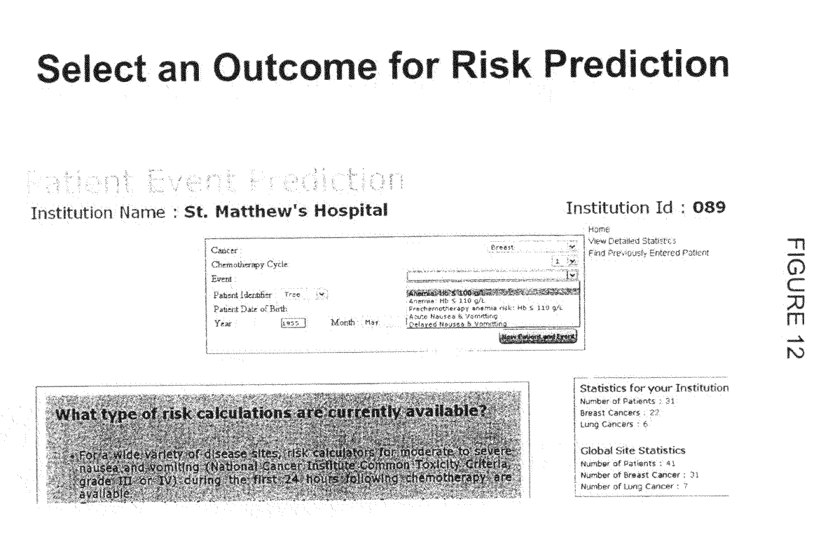

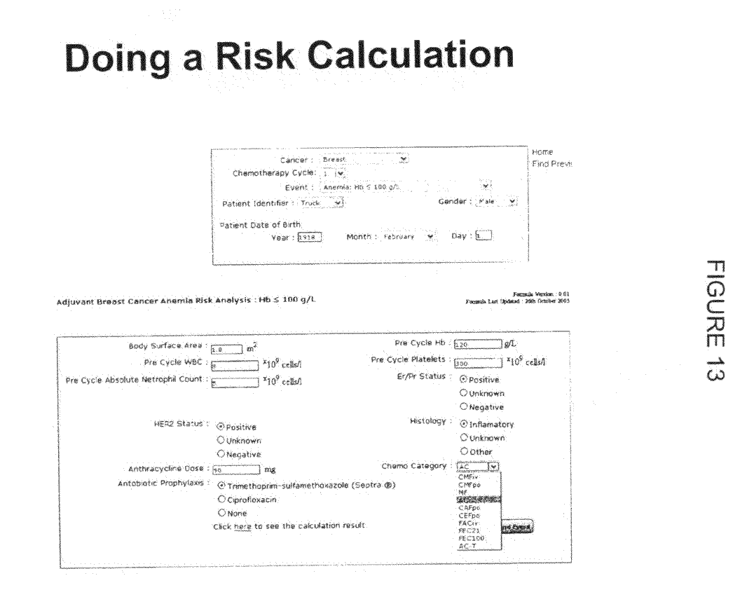

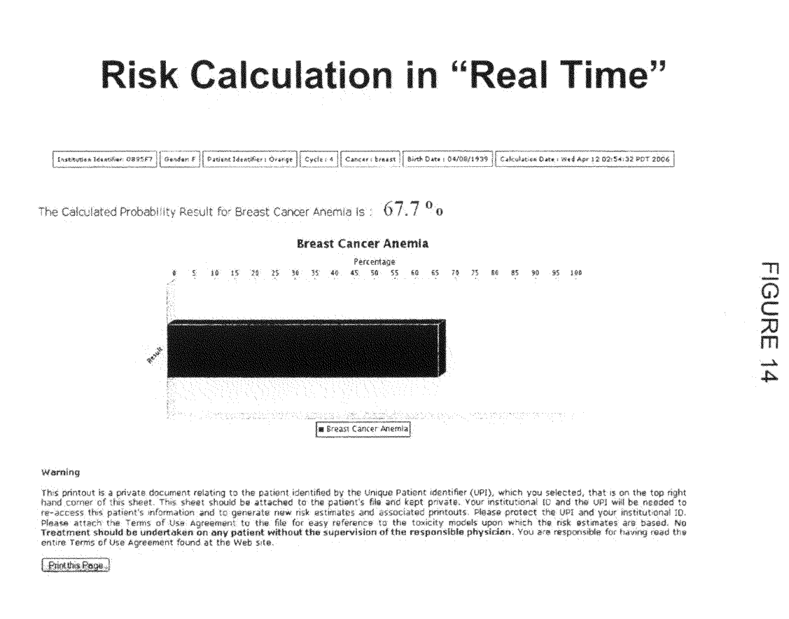

An example of a web-based system in one embodiment of the present invention is shown in FIGS. 8 through 14. This embodiment relates to a web-based system for predicting toxicities associated with treatment options for cancer. As can be seen from FIG. 8, a user accessing the web-based portal is provided with a welcome page that describes various features of the system. The Welcome page can include additional features, such as a news service (see FIG. 9), advertisements, sponsorship information, legal disclaimers, and the like. The Welcome page can further include a log-in option (see FIG. 8) or this can be provided on a new page (see FIG. 10) accessed by a hyperlink from the Welcome page. Once the user has logged in, a disease site is selected (see FIG. 11), for example, by typing in the disease site or by selection from a drop-down menu. The next step is to select a chemotherapy cycle number and an event for risk prediction (see FIG. 12). Patient data required by the prediction model is entered in the following step (see FIG. 13). The risk calculation is then performed by the system and displayed as a percentage and as a bar graph (see FIG. 14).

The web-based system can further provide graphic outputs relating to Institutional usage statistics and global statistics using the data input from all institutions, which allows a user to ascertain the average level for one or more clinical parameters for similar patients in the patient's hospital and globally. For example, the clinical parameters could be Hb level, white blood cell count, platelet levels and neutrophil count, by cycle of chemotherapy.

### Method for Developing Negative Event Prediction Models

The present invention further provides for a method of developing negative event prediction models that are suitable for incorporation into the system described above. The prediction models allow the probability that an individual patient will experience a negative event to be determined. The method comprises the following steps:
(i) assembling clinical data representing a patient population having a disease of interest, said clinical data including event data relating to the presence, absence and/or severity of one or more negative events, wherein at least 5% of said patient population has experienced one or more negative events;
(ii) classifying the clinical data into classified data defining a plurality of potential risk factors;
(iii) processing the classified data to identify initial risk factors and selecting secondary data comprising the initial risk factors;
(iv) subjecting the secondary data to a first analysis to generate a general system based on the initial risk factors, and
(v) subjecting the general system to a second analysis to identify primary risk factors and thereby generate a negative event prediction model based on the primary risk factors.

The method according to the present invention will be described in more detail below with reference to specific embodiments of the invention relating to the prediction of cancer-specific toxic events.

### Method for Developing Cancer-Specific Toxic Event Prediction (C-STEP) Models

In one embodiment of the present invention, there is provided a method for developing a prediction model that determines the likelihood that a cancer patient will experience a toxic event related to the chemotherapy the patient is currently undergoing, or about to undergo. In this context, a “toxic event” refers to a chemotherapy-related toxicity having a quantifiable characteristic allowing the presence or absence of the toxic event to be diagnosed. Examples of such toxic events include, but are not limited to, neutropenia, thrombocytopenia, anaemia, nausea and vomiting, diarrhoea, stomatitis, alopecia, peripheral neuropathy, renal impairment, venous thrombolic events, cardiac toxicity (e.g. congestive heart failure), cognitive dysfunction, clinical depression and skin toxicity. In one embodiment of the present invention, the toxic event is a haematologic toxic event, such as, neutropenia, thrombocytopenia or anaemia. In another embodiment, the toxic event is anaemia.

The method comprises the following steps:

(1) assembling clinical data representing a cancer patient population;
(2) classifying the clinical data by chemotherapy cycle into cycle-classified data defining a plurality of potential risk factors;
(3) processing the cycle-classified data to identify initial risk factors and selecting secondary data comprising the initial risk factors;
(4) subjecting the secondary data to a first analysis to generate a general model based on the initial risk factors;
(5) subjecting the general model to a second analysis to identify primary risk factors and thereby generate a cancer-specific toxic event prediction (C-STEP) model based on the primary risk factors.

### Step 1: Assembling Clinical Data

Clinical data is assembled from a patient population representing the cancer of interest. In order to provide suitable clinical data for method of the invention, the individual patients that make up the patient population should meet the following minimum criteria:

(a) the patient must have the cancer of interest; and
(b) the patient must have undergone at least one cycle of chemotherapy, and
(c) at least about 5% of the population must have developed the chemotherapy related toxic event under investigation.

The patient population should be of a suitable size, as described in detail above. The clinical data assembled in step 1 of the method represents the patient population and comprises: (i) type of chemotherapy and cycle of chemotherapy, (ii) evaluations of a quantifiable characteristic of the toxic event of interest pre-chemotherapy and post-chemotherapy, and (iii) other clinical parameters.

The clinical data can be derived from clinical studies, from the scientific literature or from existing databases, as described above. In one embodiment of the present invention, the clinical data is derived from the European Cancer Anaemia Survey (ECAS) database (see Ludwig, et al., Eur. J. Cancer, 2004, 40:2293-2306).

For part (ii) above, a quantifiable characteristic of the toxic event is evaluated prior to and after chemotherapy allowing for a determination as to the presence or absence of the toxic event in a patient. The “quantifiable characteristic” can be evaluated through measurement, or it can be evaluated by comparing the severity of a characteristic with a standard scale and then according a “grade” to the toxic event. For example, when the toxic event is anaemia, pre-chemotherapy and post-chemotherapy haemoglobin levels can be measured; when the toxic event is neutropenia, pre-chemotherapy and post-chemotherapy white blood cell counts can be evaluated; for the toxic event thrombocytopenia, pre-chemotherapy and post-chemotherapy platelet counts can be evaluated. For other chemotherapy related toxic events, such as nausea, fever and the like, the severity of the event can be graded, as indicated above.

### Chemotherapy

As indicated above, patients in the patient population must have undergone at least one cycle of chemotherapy. When a patient has undergone more than one cycle of chemotherapy and the quantifiable characteristic of the toxic event has been determined before and after each cycle of chemotherapy, this information is included in the clinical data that is assembled in this step of the method.

The patient population can be limited to patients who are being treated with one of a certain set of chemotherapeutics, for example, chemotherapetiucs that are commonly used in first line or adjuvant therapy against a disease, or chemotherapeutics known to influence the likelihood that patient will develop the toxic event under investigation.

In one embodiment of the present invention, the method is used to develop a model using clinical data from a patient population being treated with at least one of the following chemotherapeutics: bleomycin, bexarotene, bortezomib, capecitabine, carboplatin, chlorambucil, cisplatin, cyclophosphamide, cytarabine, daunorubicin, docetaxel, doxorubicin, epirubicin, estramustine, etoposide, fludarabine, 5-fluorouracil, gemcitabine, gemtuzumab, idarubicin, ifosfamide, interleukin-2, iodine 131 tositumomab, irinotecan, melphalan, methotrexate, mitoxantrone, oxaliplatin, paclitaxel, pemetrexed, procarbazine, raltitrexed, rituximab, thalidomide, tiuxetan, tositumomab, vinblastine, vincristine, vindesine, vinorelbine, yttrium 90-labeled ibritumomab.

In one embodiment of the present invention, the method is used to develop a model for breast cancer or non small cell lung cancer using clinical data from a patient population being treated with at least one of the following chemotherapeutics: cyclophosphamide, 5-fluorouracil, methotrexate, doxorubicin, epirubicin, paclitaxel, docetaxel, cisplatin, carboplatin, gemcitabine, vinorelbine, etoposide, vinblastine or vindesine.

In another embodiment, the method is used to develop a model for colorectal cancer using clinical data from a patient population being treated with at least one of the following chemotherapeutics: 5-fluorouracil, irinotecan, oxaliplatin, capecitabine, raltitrexed, avastin, erbitrux and pentimumab.

In another embodiment, the method is used to develop a model for head and neck cancer using clinical data from a patient population being treated with at least one of the following chemotherapeutics: 5-fluorouracil, paclitaxel, docetaxel, cisplatin, carboplatin, or ifosfamide.

In another embodiment, the method is used to develop a model for lymphoma using clinical data from a patient population being treated with at least one of the following chemotherapeutics: cyclophosphamide, 5-fluorouracil, methotrexate, doxorubicin, epirubicin, cisplatin, carboplatin, gemcitabine, vinorelbine, chlorambucil, vinblastine, vincristine, procarbazine, bleomycin, bexarotene, rituximab, ifosfamide, cytarabine, fludarabine, idarubicin, tositumomab, iodine 131 tositumomab, yttrium 90-labeled ibritumomab, or tiuxetan. The patients may also have received radiotherapy.

In another embodiment, the method is used to develop a model for leukaemia using clinical data from a patient population being treated with at least one of the following chemotherapeutics: methotrexate, doxorubicin, epirubicin, cisplatin, carboplatin, gemcitabine, vinorelbine, chlorambucil, vincristine, procarbazine, bleomycin, bexarotene, rituximab, ifosfamide, cytarabine, fludarabine, idarubicin, daunorubicin, etoposide, daunorubicin, mitoxantrone, cytosine arabinoside or gemtuzumab.

In another embodiment, the method is used to develop a model for myeloma using clinical data from a patient population being treated with at least one of the following chemotherapeutics: melphalan, vincristine, doxorubicin, thalidomide, or bortezomib.

In another embodiment, the method is used to develop a model for male urogenital cancer using clinical data from a patient population being treated with at least one of the following chemotherapeutics: paclitaxel, cisplatin, carboplatin, docetaxel, gemcitabine, methotrexate, doxorubicin, vinblastine, estramustine, mitoxantrone, interleukin-2, bleomycin, etoposide, ifosfamide, or 5-fluorouracil.

### Quantifiable Characteristic of the Toxic Event

In order to determine the risk of occurrence of a chemotherapy related toxic event, the presence or absence of the toxic event in the patient population must be evaluated. Accordingly, in one embodiment of the present invention, a “cut-off value” for the quantifiable characteristic is established that defines the presence/absence of the toxic event.

For example, when the toxic event is anaemia, the quantifiable characteristic could be blood haemoglobin levels, wherein low levels of haemoglobin indicate the presence of anaemia. Anaemia can be defined as blood haemoglobin levels less than 120 g/L (based on the toxicity grading criteria from the National Cancer Institute and the European Organisation for Research and Treatment of Cancer), therefore, the “cut-off value” for anaemia could be established as blood haemoglobin levels less than 120 g/L.

However, alternative definitions can be employed. For example, according to the above toxicity grading criteria, blood haemoglobin levels of 119-100 g/L are classified as “mild” anaemia, blood levels of 99-80 g/L are classified as “moderate” anaemia, and blood haemoglobin levels of less than 80 g/L are classified as “severe” anaemia. In accordance with one embodiment of the present invention, anaemia is defined as blood haemoglobin levels less than or equal to 100 g/L, corresponding to a “moderate” anaemia classification according to the above toxicity grading criteria, and thus a patient in the patient population having blood haemoglobin levels of less than or equal to 100 g/L is characterised as anaemic. In other embodiments of the invention, the patient is characterised as anaemic when levels of blood haemoglobin are less than or equal to 120 g/L, less than or equal to 110 g/L, less than or equal to 90 g/L, or less than or equal to 80 g/L.

For other toxic events the quantifiable event can be the grade or severity of the event, for example a patient can be considered to be experiencing a toxic event when the event is severe, typically grade III or IV.

Accordingly, the method of the invention employs a binary dependent variable that relates to the toxic event of interest for which a value of 0 indicates the toxic event falls outside the region defined by the cut-off value (i.e. a “no” answer) and a value of 1 indicates the toxic event falls within the region defined by the cut-off value (i.e. a “yes” answer). For example, when anaemia is the toxic event, a binary dependent variable can be created, wherein “yes” indicates that a patient had a post chemotherapy blood haemoglobin level less than or equal to a predetermined cut-off value of less than or equal to 100 g/L. Similar binary dependent variables can be created for other quantifiable characteristics with predetermined cut-off values. The cut-off point for toxicity can be flexible. For example, with graded toxicities, the cut-off can be flexible to either include or exclude grade II, depending on whether the patient is particularly sensitive or concerned about that form of toxicity.

### Other Clinical Parameters

In the context of the present invention, other clinical parameters that can be included in the assembled clinical data include, but are not limited to, age, sex, body surface area, weight (including weight loss or gain), body mass index, height, performance status (Eastern Cooperative Group or World Health Organization), stage or grade of cancer, status of cancer, disease histology, haematological laboratory values (such as counts of white blood cells, platelets, neutrophils, lymphocytes, monocytes and other white cell types, as well as the mean corpuscular volume and the RDW as a measure of the spectrum of red cells in the blood), biochemical laboratory values (such as serum albumin, total protein, blood calcium, liver function tests (alanine and aspartate transaminase), gamma GT, alkaline phosphatase, total bilirubin (conjugated and unconjugated bilirubin), renal parameters (including urea, creatinine and creatinine clearance)) and information regarding additional/complementary treatments (such as antibiotic treatment, hormone treatment and the like), prior or concurrent or intended radiotherapy, prior chemotherapy (including type of chemotherapy, the dose of chemotherapy, the schedule of chemotherapy and any dose reductions necessary in the chemotherapy), and prior or concurrent hormone therapy.

Other useful clinical parameters include, for example, lactate dehydrogenase levels; elevated blood glucose (as an indication of diabetes mellitus); other biochemical parameters such as TNF alpha, interleukin-6 and other cytokines; hemopoietic factors such as iron, total iron binding capacity, percent saturation, serum folate, red cell folate, serum B12 and homocysteine (as an indicator of serum folate), and serum ferritin, which can be an indication of disease bulk as well as iron status; serum albumin; prior or current hematinic therapy, such as iron or folate; the existence or absence of prior anaemia; the presence or absence of other comorbidities (especially chronic obstructive pulmonary disease, which may be associated in a normal person with elevated hemoglobin); the histological subtype of the tumour, the extent of prior surgery and the date of prior surgery; any evidence of recent blood loss or hemorrhage; recent or planned blood transfusion (including number of units transfused); weight loss over a specified period of time; the presence or absence of shortness of breath; and in addition to the other clinical parameters, also the type of chemotherapy, the dose of chemotherapy, the schedule of chemotherapy, and this would apply to all of the chemotherapeutic agents used currently or used in the past; dose reductions necessary in the chemotherapy; the use of colony stimulating factors to stimulate any element of hematopoiesis, especially erythropoietin and/or granulocyte (macrophage) colony stimulating factor; oxygen use (including oxygen saturation PaO2); other measurements of blood gases and blood pH; and the stage of the cancer.

One skilled in the art will understand that for certain cancers the clinical evaluation may provide additional parameters that are specific to that cancer, such as tumour markers. For example, for breast cancer, the presence or absence of the human epidermal growth factor receptor HER2, the estrogen receptor and/or progesterone receptor can be included. Similarly, CEA can reflect tumour bulk in colorectal cancer.

For the purposes of the present invention, each of these other clinical parameters represents a potential risk factor.

Where clinical parameters have been assessed between cycles of chemotherapy, this information can also be included in the clinical data, thus providing for the adjustment of the predictive risk for the next cycle of chemotherapy, i.e. the type of toxicity that occurred in the previous cycle can be incorporated into the assessment of the next cycle.

Step 2: Classifying the Clinical Data by Chemotherapy Cycle into Cycle-Classified Data

In this step, the clinical data assembled in step 1 is classified according to the number of cycles of chemotherapy that the patient has undergone, such that the clinical data is grouped by cycle number, rather than by patient. In one embodiment, the classification step can be initiated and performed sequentially with the assembly of the patient population.

### Step 3: Processing the Cycle-Classified Data to Identify Initial Risk Factors and Selecting Secondary Data Comprising the Initial Risk Factors

As indicated above, the cycle-classified data comprises a plurality of potential risk factors, which can aid in the determination of the risk of a particular toxic event for a specific cancer-type. As a specific cancer-type may produce one or more detectable variations in one or more of the potential risk factors contained in the cycle-classified data, a specific cancer-type may have its own form of signature in relation to these potential risk factors in relation to a particular toxic event. As such the specific cancer-type can have associated therewith a particular set of initial risk factors in relation to the particular toxic event. Therefore, for the specific cancer-type, the cycle-classified data is processed in order to evaluate the level of confidence that each of these potential risk factors will have a consistent impact on the prediction of the particular toxic event for the predefined specific cancer-type. This evaluation process provides a means for determining the initial risk factors for inclusion in the first analysis stage for generation of the general model. These initial risk factors are selected from the plurality of potential risk factors, through a selection process based on a predefined level of confidence of their consistent impact on the desired prediction' outcome. In this manner, the potential risk factors that contribute to the desired prediction outcome in a consistent manner defined by a predefined level of confidence, are selected as the initial risk factors and the remaining potential risk factors are discarded. As such the secondary data comprises a sub-set of the cycle-classified data, and this secondary data represents the initial risk factors determined during the processing of the cycle classified data.

The process for the determination of the level of confidence for each of the potential risk factors can be performed in any of a number of manners that can define the statistical significance that aids in the determination of the degree of confidence one can have in accepting or rejecting a particular hypothesis. For example, this processing step can determine the level of confidence for a hypothesis stating a potential risk factor has a consistent impact on the prediction of the particular toxic event for the specific cancer-type. Depending on the determined level of confidence, the selection of the potential risk factor can be defined, namely if the level of confidence is above a predefined level then the hypothesis is taken to be true and therefore the evaluated potential risk factor is selected as an initial risk factor. This processing step can be performed by a plurality of methods including the Chi-square test, t-tests, evaluation of Pearson's Correlation coefficient, an analysis of variance, or any other suitable confidence level evaluation process or statistical analysis as would be readily understood by a worker skilled in the art.

In one embodiment of the present invention, the Chi-square test is used to determine if a potential risk factor has a predetermined level of confidence of its consistent contribution to the prediction of the particular toxic event for the specific cancer-type. The Chi-square test is a non-parametric test of statistical significance and it can provide an estimate of the level of confidence whether or not two different samples are different enough in a characteristic or aspect of their behaviour that a generalization can be made that the data set from which the samples are selected are also different in this characteristic or aspect of behaviour. For example, a threshold for the predetermined level of confidence can be selected as 50%, 10%, 5% or 1% for example, wherein this threshold can define the probability that the observed difference occurred by chance alone. In one embodiment, this threshold is set at 25% or lower, which defines the level of confidence as 75% or higher that a potential risk factor has a consistent impact, thereby identifying that particular potential risk factor as an initial risk factor.

In one embodiment of the present invention the Chi-square test performed is an un-corrected Chi-square test for binary variables.

### Step 4: Subjecting the Secondary Data to a First Analysis to Generate a General Model Comprising the Initial Risk Factors

Upon the evaluation of the secondary data which comprises the initial risk factors, a first analysis is performed to determine a general model that can take as input the initial risk factors and subsequently output a prediction of the risk of the particular toxic event for the specific cancer-type. The first analysis provides a means for the evaluation of the level of contribution that each of the initial risk factors has on the prediction of the risk thereby providing a means for the generation of the general model.

The first analysis for the generation of the general model can be performed in any of a number of manners that can define a correlation between the initial risk factors and the desired prediction of risk of the particular toxic event for the specific cancer-type. For example this analysis can enable the determination of correlation factors for each of the initial risk factors, wherein each of these correlation factors provide a means for defining the contribution of each of the respective initial risk factors to the prediction of the risk of the particular toxic event for the specific cancer-type. This processing step can be performed by a plurality of methods comprising numerous multivariate statistical analyses including a multivariate linear regression analysis, a multivariate logistic regression analysis, principle components analysis, discrete time models, parametric and non-parametric event history models, a neural network or other suitable analyses as would be readily understood by a worker skilled in the art.

In one embodiment of the present invention, multivariate logistic regression is used to analyze the initial risk factors in relation to a dependent variable selected as the probability of the occurrence of the particular toxic event, thereby enabling the generation of the general model that defines the correlation between each of the initial risk factors and the prediction of the risk of the particular toxic event of the specific cancer type. For example, the general model can be defined as follows:

$$ln ( \frac{P}{( 1 - P )} ) = a + {\sum }_{i = 1}^{n} {b}_{1} {x}_{1}$$

wherein P is the probability of the particular toxic event occurring, a is a constant, bᵢ is a model constant associated with the initial risk factor xᵢ, and wherein there are n initial risk factors.

### Step 5: Subjecting the General Model to a Second Analysis to Identify Primary Risk Factors and Thereby Generate a Cancer-Specific Toxic Event Prediction (C-STEP) Model Comprising the Primary Risk Factors

Upon the generation of the general model for the specific cancer type, this general model is subsequently subjected to a second analysis in order to identify the primary risk factors. In this manner the design of the general model can be augmented into an alternate simplified configuration, while retaining a desired level of consistency in the prediction of the risk of the particular toxic event when compared to the general model previously generated. In this manner, the cancer-specific toxic event prediction (C-STEP) model is substantially an equally accurate model, when compared to the general model, however the C-STEP model provides for simpler determination of the prediction of the risk of the particular toxic event for a specific cancer-type.

The second analysis, which is used to evaluate the general model, can be performed in a number of manners that can evaluate the overall contribution that each of the initial risk factors has on the overall result provided by the general model. During this second analysis each of the initial risk factors associated with the general model are analyzed for their respective contributions. In one embodiment, this second analysis is performed on a factor-by-factor basis thereby resulting in the determination of the primary risk factors. The determination of these primary risk factors can provide a means for the generation of the C-STEP model. The second analysis can be performed using a resultant error evaluation, a likelihood-ratio test, Akaike's Information Criterion (AIP) and Final Prediction Error (FPE) or other suitable analyses as would be readily understood by a worker skilled in the art.

In one embodiment of the present invention, the second analysis comprises the use of the likelihood-ratio test for the evaluation of the contribution of each of the initial risk factors to the overall prediction. For example, the likelihood-ratio test is a statistical test that determines a particular value that is computed by taking the ratio of the maximum value of the likelihood function assuming the constraint of the null-hypothesis to the maximum value with that constraint relaxed. For example, taking the null-hypothesis to be that the selected initial risk factor is important, when the ratio defined by the prediction including the selected risk factor to the predication excluding the selected risk factor exceeds a predetermined threshold, that initial risk factor is considered important. For example, a threshold defining importance can be selected as 50%, 10%, 5% or 1% for example, wherein this threshold can define the tolerance of error relating to an initial risk factor's impact on the prediction of the particular toxic event for the predefined specific cancer-type. In one embodiment, the threshold is set at 5%, and as such initial risk factors that satisfy this criterion are retained for inclusion in the C-STEP model, and the remaining initial risk factors are eliminated. In this manner, one is able to determine the C-STEP model that provides for simpler determination of the prediction of the risk of the particular toxic event for a specific cancer-type, when compared to the general model.

In one embodiment of the present invention, a C-STEP model for the determination of the risk of anaemia for the specific cancer type of Advanced Non Small Cell Lung Cancer is defined as follows:

ln(P/(1−P))=3.08−(PRE CYCLE HB)*(0.073)+(AGE>=88)*(0.41)+(PATIENT PERFORMANCE STATUS=1)*(0.49)+(PATIENT PERFORMANCE STATUS=2−4)*1.11)+(DISEASE HAS RECURRED OR IS PERSISTENT)*(0.42)+(USE OF CISPLATIN OR CARBOPLATIN CHEMOTHERAPY)*(0.87)+(USE OF GEMCITABINE CHEMOTHERAPY)*(0.52)+(PRECYCLE BODY SURFACE AREA<1.97)*(1.72)

wherein P is the probability of anaemia occurring and wherein if a particular primary risk factor is not possessed by a patient that particular risk factor is considered to be equal to 0.

In another embodiment of the present invention, a C-STEP model for the determination of the risk of anaemia for the specific cancer type of Adjuvant Breast Cancer is defined as follows:

ln(P/(1−P))=24.92−(PRE CYCLE HB)*(0.25)+(AGE >=65)*(1.54)+(CYC2)*(0.31)+(CYC3)*(0.46)+(CYC4)*(0.95)+(CYC5)*(0.89)+(CYC6)*(1.52)+(CYC7)*(0.59)+(CYC8)*(1.49)+(CYC9)*(1.15)+(CYC10)*(2.0)+(CYC11)*(0.87)+(CYC12)*(1.54)+(USE OF THE ANTIBIOTIC SEPTRA DURING THE CHEMOTHERAPY)*(0.50)+(USE OF THE ANTIBIOTIC CIPROFLOXACIN DURING THE CHEMOTHERAPY)*(0.53)+(CHEMOTHERAPY CONSISTING OF CAF OR CEF)*(1.62+(CHEMOTHERAPY CONSISTING OF EITHER CAF, CEF21, FEC100, AC-TAXOL)

wherein P is the probability of anaemia occurring and wherein if a particular primary risk factor is not possessed by a patient that particular risk factor is considered to be equal to 0. And wherein:

CYC# represents the chemotherapy cycle number (up to 12).

CAF: cyclophosphamide given by mouth on daily from day 1 to day 14. Doxorubicin given by iv on day 1 and day 8. 5-fluorouracil given iv on day 1 and 8. This is repeated every 28 days and represents 2 cycles.

CEF: cyclophosphamide given by mouth on daily from day 1 to day 14. Epirubicin given by iv on day 1 and day 8. 5-fluorouracil given iv on day 1 and 8. This is repeated every 28 days and represents 2 cycles.

FEC21: cyclophosphamide given by iv on day 1. Epiribicin given by iv on day 1. 5-fluorouracil given iv on day 1. This is repeated every 21 days and represents 1 cycle

FEC100: cyclophosphamide given by iv on day 1. Epiribicin given by iv on day at a dose of 100 mg/m2 (dose in other regimens is between 50 to 70). 5-fluorouracil given iv on day 1. This is repeated every 21 days and represents 1 cycle.

CAFIV: cyclophosphamide given by iv on day 1. Doxorubicin given by iv on day. 5-fluorouracil given iv on day 1. This is repeated every 21 days and represents 1 cycle.

AC-TAXOL: doxorubicin and cyclophosphamide given together by iv on day 1 for four cycles, followed by paclitaxel alone by iv for another four cycles, leading to a total of eight cycles (Citron M et al., 2003, J Clin Oncol 21: 1431-39).

It would be readily understood that a worker skilled in the art, having regard to the instant application would readily understand how to determine a C-STEP model for other specific cancer-types and these alternate C-STEP models should be considered to be within the scope of this invention.

### Optional Additional Step: Development of a Risk Scoring Model

In one embodiment of the present invention, a risk scoring model is defined for each specific cancer-type, wherein each risk scoring model directly correlates to the respective C-STEP model associated with that specific cancer-type. The risk scoring model can provide a means for further simplification of the C-STEP model, and may provide a means for medical personnel to predict a risk of the particular toxic event without the immediate activation of the respective C-STEP model. The risk scoring model is configured to provide an evaluation number between 1 and 50, which can subsequently be mapped to a respective prediction of the risk of the particular toxic event for the patient in question. It would be readily understood that the risk scoring model can equally enable the evaluation of a number between 1 and 100, or 50 and 200 or any other scale, provided that this number is appropriately mapped to the desired prediction of risk. In one embodiment of the present invention, the risk scoring model provides a risk of the particular toxic event for the patient in question expressed as a percentage.

In one embodiment, the risk scoring model associated with the C-STEP model for the prediction of the risk of anaemia for a specific cancer-type can be determined by modifying the C-STEP model such that each of the model coefficients are rounded up to the nearest whole number, with the exception of the model coefficient associated with the Pre Cycle Haemoglobin level which is not altered. The resulting values for each of the primary risk factors times their respective modified model coefficient are added together, and the respective constant of the C-STEP model is further added to the value, thereby obtaining an initial value. Depending on the specific type of cancer under question, this initial value may be further augmented by a secondary constant.

In one embodiment, for the prediction of the risk of anaemia for the specific cancer-type of Advanced Non Small Cell Lung Cancer the secondary constant is 10. For the prediction of the risk of anaemia for the specific cancer type of Adjuvant Breast Cancer the secondary constant is 25. It would be readily understood that this secondary constant may be arbitrarily selected, and in this embodiment it is selected to enable the determination of consistently positive values for the risk scores.

### Refining the C-Step Models

In one embodiment of the present invention, the C-STEP model for each specific cancer type is configured to be a learning model, wherein upon the receipt of additional relevant and acceptable patient data, a modification of the C-STEP model may be enabled which may provide a means for improving the accuracy of the prediction of the risk of the particular toxic event for the specific cancer type by the C-STEP model. It would be understood that the activation of a learning sequence for the modification of the C-STEP model may be initiated upon the collection of a sufficiently large amount of additional data.

In one embodiment of the present invention, wherein the C-STEP model is implemented as a web-based application, the web-based application can comprise data capture capabilities in order to capture relevant data from users of a specific C-STEP model, wherein this data can subsequently be used for the refinement and updating of that specific C-STEP model.

### Use of the System

Various uses of the system of the present invention will be readily apparent from the detailed description provided above. The system of the present invention can be used to guide the selection of treatment options for a patient based on assessment of the available clinical data in conjunction with patient preferences and physician recommendations and allow the development of an individualised treatment regimen for the patient.

The present invention also contemplates that the system can be used for educational purposes, for example, in the education of medical students or the continuing education of various healthcare professionals.

The system can be utilized as part of the initial consultation between a patient and physician, before the precise treatment decision is made when contemplating alternatives; and/or it can be used during the course of treatment, for example, cycle by cycle to decide whether any other interventions need to be made to minimize toxicity, such as dose reduction, institution of supportive care, medication, and the like. Thus the system can be used to contemplate alternative treatments, as well as to help minimize toxicity once the treatment has begun, for example, over the several cycles of chemotherapy that usually constitute a course of chemotherapy (for example, 6 or more cycles).

The system allows for rapid assessment of the available treatment options, for example, by presenting comparative data or prediction values in a graphical format, which in turn allows for well-informed decisions to be made in contexts where time is at a premium, such as busy clinics. The system can also improve the process of obtaining informed consent from a patient in providing the patient with the necessary information in a readily understandable format that, can in various embodiments, provide a semi-quantitative comparison of treatment options.

For example, the system can be used to establish a baseline risk of a particular toxicity or several/all of certain toxicities, so that as a medical professional can select a regimen or schedule or dose or cycle number, least likely to cause the most important toxicities. According to (i) patient preference or fear, (ii) patient vulnerabilities (what toxicity is the patient most likely to be vulnerable to), (iii) as to whether or not an appropriate monitoring system can be put in place, and (iv) the consequences of the toxicity should it actually happen, some consequences being worse than others. All of these precautions are being taken at the same time not compromising the chemotherapy's ability to deliver at least a certain minimum level of efficacy or more; this information enabling the medical professional and the patient to optimize the choice of chemotherapy providing the best trade-off between efficacy and toxicity in a manner that can be readily understood by both the medical professional and the patient.

By utilising the system of the present invention, a medical professional will able to provide appropriate patient education and monitoring with respect to early recognition of toxicity and an appropriate and prompt action plan. The medical professional will also be able to prescribe a supportive care medication at the optimal time, i.e. not unnecessarily early (thus saving money, time, and avoiding adverse events referable to the specific supportive care medication), but not too late either, thus enabling the patient to avoid the toxicity (or most of it, or the worst of it) altogether.

Furthermore, during a particular chemotherapy regimen, the medical professional can use the system to obtain a risk of toxicity at the next cycle, and decide if chemotherapy should be discontinued, i.e. it enables the medical professional and the patient to weigh the risk/benefit ratio with each succeeding cycle and this information to be conveyed in a manner to be understandable by most patients, so as to incorporate patients into the decision making. The system can also be used to determine whether to dose escalate the chemotherapy if the risk of toxicity is low, or to implement a dose delay or dose reduction, or a change in a regimen or schedule, thereby allowing individualized treatment. Similarly, if the system indicates that a toxicity cannot be avoided or minimized, the medical professional will have an opportunity to gauge the willingness of a patient to endure a particular toxicity in the event it arises; in this manner the patient will have more control over the therapy. Conversely, should the system indicate that a risk of toxicity will decline, for example if the dose had to be reduced or the regimen changed for other reasons; this could give the medical professional the opportunity to stop a supportive care medication thus reducing treatment costs. For example if the dose had to be reduced because of neutropenia, the patient may be at a lower risk of anaemia and might be able to stop the erythropoietin, thus reducing treatment costs.

For example, with respect to the toxic event anaemia, the system can be used to assess the risk that a patient will develop anaemia during chemotherapy and thus provide an indication as to whether prophylactic anaemia treatment (e.g. with epoietin alpha) should be initiated. The system thus allows for a pro-active approach to treatment in that prophylactic treatment can be initiated in a patient determined to have a high risk of developing anaemia at an optimal time with a view to averting the occurrence or minimising the level of anaemia in the patient. On the other hand, if the system predicts that the patient is at very low risk of anaemia, prophylactic treatment that will raise Hb levels (e.g. epoietin alpha) can be averted. As is known in the art, too high an Hb level can lead to complications such a thrombosis and it is, therefore, desirable to avoid the occurrence of overly high Hb levels.

Additional information can also be obtained utilising the prediction model that relates to the primary risk factors identified by the system for a specific cancer type. For example, information may be obtained relating to the cycle of chemotherapy at which the toxic event is most likely to develop, or the chemotherapy regimen(s) that are most likely to lead to occurrence of the toxic event. The system can, therefore, be employed to help develop a treatment strategy for the patient, for example, with respect to an optimal number of chemotherapy cycles to minimise the risk of a patient experiencing the toxic event, selection of an appropriate chemotherapeutic, such as the chemotherapeutic least likely to contribute to the occurrence of the toxic event, selection of a reduced dose to minimise toxicity, or the point at which treatment should be initiated to minimise the level of, or avert the occurrence of, the toxic event.

The system can also be used by patients to independently ascertain their risks, i.e. patients could access this over the Internet independent of their physicians and thus become more informed and able to productively discuss any issues with their physician.

The system of the present invention can be implemented using a variety of suitable technologies. For example, the system may be constructed or programmed into a spreadsheet application wherein the user supplies the necessary information and the system uses the supplied data to provide the required output and/or determine the risk of the patient experiencing the negative event. Similarly, the system may be employed as a self-contained computer application or applet. Rather than entering data into a spreadsheet, the user may be presented with graphic data choice boxes or buttons, such as drop-down menus, slider bars or “radio buttons” which are commonly used in Internet or web-based applications. These data choice mechanisms allow the user to choose the desired value for each of the required variables. The present invention also contemplates the generation of paper handouts or other hard copy materials, which could enable physician and patient decision making.

In addition using a website approach, data capture capabilities can be created in order to capture relevant data from users of the system. This data can then be used for the continual refinement and updating of the system.

It would be readily understood that the location of a computing device upon which the system generated by the present invention is housed, is not to be limiting. For example, the computing device having the system thereon can be a local device, for example within a clinic or doctors office, or optionally can be a centrally located computing device, wherein for example a clinician, doctor or patient can remotely access the computing device via a communication network. The present invention also contemplates that the system can be accessed wirelessly using wireless and handheld devices, such as tablets and PDAs.

In one embodiment of the present invention, the system a web-based application. In another embodiment, the system is housed on a centrally located computing device, wherein for example a clinician, doctor or patient can remotely access the computing device via a communication network, such as via the Internet.

It will be appreciated that, although specific embodiments of the method of the invention and the systems generated thereby have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and the system generated thereby and/or to structure its components in accordance with the system of the invention.

Further, each step of the method and the system generated thereby may be executed on any general computer, such as a personal computer, server or the like and pursuant to one or more, or a part of one or more, program elements, modules or objects generated from one of a number of suitable programming language, such as C++, Java, Pl/1, or the like. In addition, each step, or a file or object or the like implementing each said step, may be executed by special purpose hardware or a circuit module designed for that purpose.

The invention will now be described with reference to specific examples. It will be understood that the following examples are intended to describe embodiments of the invention and are not intended to limit the invention in any way.

### EXAMPLES

### Example 1

### The Development and Validation of a Prediction Tool for Chemotherapy-Induced Anaemia in Patients with Advanced Non-Small Cell Lung Cancer Receiving Palliative Chemotherapy

### Methods

Patients: Data used in this Example was collected from NSCLC patients (n=536) with stage Mb or IV who were prospectively evaluated as part of the multicentre European Cancer Anemia Survey (ECAS) conducted in 24 European countries (Ludwig H, et al. Eur J Cancer 2004; 40:2293-2306). The data collection included patient demographic and disease related information, patient weight, body surface area (BSA), World Health Organization (WHO) performance status, disease stage, baseline, pre and post chemotherapy cycle Hb, white blood cells (WBC), absolute neutrophil count (ANC), platelets, concomitant radiation therapy, weight loss and type of chemotherapy. Patients who received prophylactic recombinant erythropoietin were excluded, but patients who received transfusion support were included as this is the standard of care in Canada. Data was collected on a second sample of advanced stage patients (n=76) treated between 2004 and 2005 at the Toronto Sunnybrook Regional Cancer Centre, located in Toronto, Canada. From the first cycle until the completion of chemotherapy, data collection included the dose of individual drugs, total number of cycles delivered, number of dose reductions and delays and total number of red blood cell units administered.

Development of the Prediction Model and Scoring System: To develop a cycle-based prediction model, the patient sample (n=536) from the ECAS study was randomly divided into a two-thirds derivation and one-third internal validation dataset. Patient demographic and clinical characteristics were presented descriptively as mean, medians or proportions. Before the full analysis was initiated, the relevant covariates for initial model inclusion were identified by a univariate screening process with a preset alpha=0.25. This is a recommended approach for removing unimportant covariates so that a more manageable set of variables can be submitted to multivariate techniques (George S L. Semin Oncol 1988; 15:462-71). The univariate odds ratio (OR) for anaemia from each of the remaining risk factors alone (post screening) was then estimated. To determine the final predictive factors for retention into the model, multivariable logistic regression analysis adjusted for clustering on the patient was applied (Allison P D. Logistic Regression Using the SAS System: Theory and Application; Chapter 8; p 179-216. Cary, N.C.: SAS Institute Inc., 1999). This adjustment for clustering is required because observations between multiple cycles of chemotherapy within a given patient violates the independence assumption of logistic regression. The Likelihood ratio test was used in a backwards elimination process (p<0.05 to retain) to select the final covariates for retention into the model. A pre-planned evaluation of interaction effects between types of chemotherapy failed to identify significant effects. The final risk factors were then given a statistical weight based on the regression model coefficients. A risk scoring system was then developed with a score ranging from 0 to 15. A risk score was assigned to each patient by adding points for each risk factor they had.

Validation of Prediction Model: The predictive accuracy of the final model and risk scoring system was determined by measuring the specificity, sensitivity and area under the Receiver Operating Characteristic (ROC) curves in both the derivation and validation samples (McNeil B J, Hanley J A. Med Decis Making. 1984; 4:137-50). Discrimination refers to the ability of a diagnostic test or predictive tool to accurately identify patients at low and high risk for the event under investigation and is often presented as the area under the ROC curve. A predictive instrument with an ROC of ≧0.70 is considered to have good discrimination, and an area of 0.5 is equivalent to a “coin toss” (Krupp N L, Weinstein G, Chalian A. Arch Otolaryngol Head Neck Surg. 2003; 129:1297-302). In the current Example, two sets of validation were performed with an internal and external sample. The internal validation sample consisted of one-third of our original ECAS patient cohort (n=179) that had been randomly selected. The external validation sample consisted of advanced stage patients (n=76) treated between 2004 and 2005 at the Toronto Sunnybrook Regional Cancer Centre, located in Toronto, Canada. All of the statistical analyses were performed using Stata, release 9.0 (Stata Corp., College Station, Texas, USA).

### Results

The 357 patients in the derivation sample received 1156 cycles of chemotherapy, resulting in a median of 4 cycles (range 1-7). Approximately 9.2% of patients were anaemic at study entry. By the final cycle of chemotherapy, 41.5% (148) of patients became anaemic, defined as a blood Hb less than or equal to 100 g/L. Patients from the model derivation and validation datasets were comparable with respect to mean age, body surface area, disease status and haematological characteristics (Table 1). Over the evaluation period, 20.7% of patients in the model derivation sample received at least one blood transfusion compared to 19.3% and 6.6% in the internal and external validation samples. Additional differences were noted between groups with respect to patient gender, disease stage, and type of chemotherapy agents administered (Table 1). Notwithstanding, it is important to recall that this is not a randomized trial, but an exercise to develop an anaemia prediction model from unique patient samples. Therefore, imbalance between validation and derivation samples should be expected and even encouraged to ensure that the prediction model can be applied to a variety of NSCLC cancer patients at any cycle of chemotherapy.

TABLE 1
Characteristic of patients in the derivation and validations samples.

| | | | Internal | | External | |
|---|---|---|---|---|---|---|
| | Derivation | | Validation | | Validation | |
| | (n = 357) | | (n = 179) | | (n = 76) | |
| Characteristic | | | | | | |
| Mean age (SD) | 59.8 | (10.7) | 59.5 | (9.5) | 61.3 | (10.2) |
| Female gender | 20.2% | | 18.4% | | 39.5% | |
| Mean BSA m² (SD) | 1.8 | (0.2) | 1.8 | (0.2) | 1.8 | (0.2) |
| Stage IV disease (vs. IIIb) | 65.5% | | 65.9% | | 51.3% | |
| Disease status | | | | | | |
| Newly diagnosed | 63.9% | | 67.6% | | 69.7% | |
| Recurrent/Persistent disease | 32.7% | | 29.6% | | 30.3% | |
| In remission | 2.2% | | 2.2% | | 0.0% | |
| Surgery in past 30 days | 3.1% | | 4.5% | | 13.2% | |
| Lost 5% of body weight in past | 25.8% | | 24.6% | | 39.5% | |
| 90 days | | | | | | |
| Mean baseline Hb [g/L] (SD) | 125 | (18.7) | 124 | (17.9) | 128 | (14.4) |
| Mean baseline WBC [×10⁹ cells/l] | 8.9 | (4.8) | 10.1 | (9.1) | 9.3 | (5.0) |
| Mean baseline platelets [×10⁹ cells/l] | 326 | (141) | 332 | (129) | 306 | (107) |
| WHO Performance Status¹ | | | | | | |
| 0 | 17.1% | | 19.0% | | N/A | |
| 1 | 56.0% | | 53.1% | | N/A | |
| 2 | 22.1% | | 23.5% | | N/A | |
| 3-4 | 4.8% | | 4.5% | | N/A | |
| Median number of cycle (range) | 4 | (1-7) | 4 | (1-7) | 5 | (1-15) |

| | | | |
|---|---|---|---|
| Concomitant radiation | 3.6% | 2.2% | 40.8% |
| Chemotherapy Agents² | | | |
| Cisplatin | 55.2% | 50.3% | 61.8% |
| Carboplatin | 29.7% | 27.1% | 14.5% |
| Gemcitabine | 35.6% | 32.8% | 26.3% |
| Docetaxel | 12.3% | 15.3% | 13.2% |
| Paclitaxel | 12.3% | 11.9% | 5.3% |
| Vinorelbine | 23.8% | 20.9% | 17.1% |
| Etoposide | 18.8% | 16.4% | 34.2% |
| Vinblastine | 3.1% | 6.2% | 0.0% |

Abbreviations:
BSA = body surface area,
N/A = data not available.
Hb = hemoglobin,
WBC = white blood count
¹Patient performance status could not be accurately derived in the external validation sample.
²Estimates do not add up to 100% because of either single agent use of combination therapy.

After the initial univariate screening (with a p<0.25) removed the unimportant covariates, the direction and magnitude of anaemia risk were measured as an odds ratio (OR) for each of the remaining variables individually. The variables with the strongest association with anaemia were pre cycle Hb, age, female gender, pre cycle. WBC, BSA, patient performance status, disease stage, disease status, loss of at least 5% body weight in past 90 days, platinum-based chemotherapy and the use of gemcitabine (Table 2). The OR for pre cycle Hb warrants interpretation. The OR for Hb was 1.09, which suggests that for every 1 g/L drop in pre cycle Hb, the relative risk for developing anaemia following that particular cycle of chemotherapy is increased by 9% (Table 2).

TABLE 2
Assessment of individual factors on the risk of anemia in the derivation
cohort.

| | Odds | | |
|---|---|---|---|
| | ratio | (95% CI) | P-Value³ |
| Risk Factor¹ | | | |
| Pre Cycle Hb (g/L) | 1.09 | (1.07-1.11) | <0.001 |
| Age ≧ 68 | 1.55 | (0.95-2.52) | 0.078 |
| Female gender | 1.50 | (0.92-2.44) | 0.10 |
| Pre Cycle WBC ≦ 9.2 (^{×} 10⁹ cells/l) | 1.74 | (1.2-2.80) | <0.001 |
| BSA < 1.97 m² | 9.25 | (3.4-25.3) | <0.001 |
| WHO PS (vs. 0) | | | |
| PS 1 | 2.0 | (0.93-4.30) | 0.076 |
| PS 2-4 | 4.65 | (2.2-10.0) | <0.001 |
| Stage IV Disease (vs. IIIb) | 2.23 | (1.31-3.80) | 0.003 |
| Recur/Persist Disease (vs. new Dx) | 1.47 | (0.93-2.31) | 0.098 |
| Lost 5% body wt in past 90 days | 1.29 | (0.79-2.11) | 0.30 |
| Platinum use² | 1.78 | (1.11-2.84) | 0.017 |
| Gemcitabine use | 1.80 | (1.16-2.79) | 0.008 |

Abbreviations:
WHO = World Health Organization,
PS = performance status,
Dx = diagnosis
¹These were the variables retained after the initial univariate screening process. Chemotherapy from the first to the final cycle was considered in the analysis.
²Cisplatin and carboplatin.
³P-values generated by the Wald Statistic, which is standard output in most statistical packages.

The development of the prediction model was then continued with the multivariable logistic regression analysis and the backwards elimination process. The final variables retained following the application of the Likelihood ratio test (p≦0.05 to retain) were pre cycle Hb, age, BSA, patient performance status, disease status, and the use of platinum-based chemotherapy or gemcitabine. The interaction between platinum-based chemotherapy and gemcitabine was not statistically significant. The variables identified as being important predictive factors for anaemia were pre cycle Hb, age a 68, BSA<1.97, poor performance status (WHO score>0), the presence of recurrent or persistent disease and the use of platinum-based chemotherapy or gemcitabine (Table 3). As expected, pre cycle Hb was an important predictor for anaemia where a 1 g/L drop was associated with a relative risk increase.

TABLE 3
Final anaemia prediction model developed from the derivation dataset.

| | | | Impact |
|---|---|---|---|
| | Odds Ratio | (95% CI) | on Anemia Risk |
| Variable¹ | | | |
| Pre Cycle Hb | 1.08 | (1.06-1.10) | Increased by 8% per |
| | | | 1 g/L drop in precycle |
| | | | Hb |
| Age ≧ 68 | 1.51 | (0.94-2.43) | Trend for increased |
| | | | risk |
| BSA < 1.97 | 5.56 | (1.85-16.7) | 5.6 fold increase |
| WHO PS (vs. 0) | | | |
| PS 1 | 1.63 | (0.74-3.59) | Trend for increased |
| | | | risk |
| PS 2-4 | 3.05 | (1.41-6.60) | 3 fold increase |
| Disease Status | | | |
| Recurrent or | 1.53 | (0.97-2.40) | Trend for increased |
| Persist Disease | | | risk |
| (vs. new Dx) | | | |
| Platinum use² | 2.65 | (1.63-4.32) | Increased 2.6 fold |
| Gemcitabine use | 1.67 | (1.07-2.63) | Increased 1.7 fold |

Abbreviations:
WHO = World Health Organization,
PS = performance status,
Dx = diagnosis
¹These are the final variables that were retained following the application of the Likelihood ratio test (p ≦ 0.05 to retain) in a backwards elimination process.
²Cisplatin and carboplatin.

A risk scoring system was then developed from the point estimates of the regression coefficients and the intercept generated from the analysis. Each of the final regression coefficients retained in the model provided a statistical weight for that factor's contribution to the overall risk of anaemia. The scoring system was then adjusted by adding a constant across all scores to ensure that none were below zero. The final product was a scoring system between 0 and 15 where higher scores were associated with an elevated risk. The starting point and score assigned to each of the predictive factors is as follows:
Start at an initial score of 13
Multiple the prechemo Hb by 0.07 and subtract from 13
If the patient≧68 yrs, add 0.5
If the patient's BSA<1.97, add 2
If patient's performance status is 1, add 0.5
If patient's performance status is 2-4, add 1
If currently treating recurrent or persistent disease, add 0.5
If patient is about to receive platinum based chemotherapy, add 1
If patient is also about to receive gemcitabine, add 0.5

Factors that add to the overall score are considered to be positive predictive factors. For instance, a BSA<1.97 requires the addition of two units and is thus a risk factor for the development of anemia. As an illustration, imagine a 70-year old women with newly diagnosed stage 1V disease, performance status 1, BSA of 1.7 and a baseline Hb of 115 g/L about to undergo her first cycle of carboplatin-gemcitabine, her risk score prior to the first cycle of chemotherapy would be 9.5.

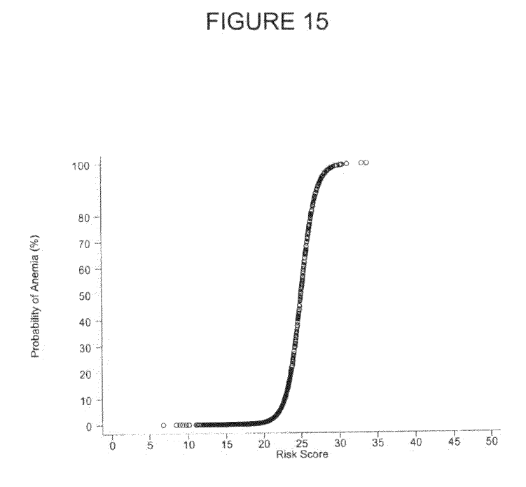

The final phase of the current study was to evaluate the accuracy of the prediction tool and to determine the score that would classify patients as “high risk”. Patient within each of the three datasets were assigned a risk score based on the above system. The risk score in the derivation dataset was then compared to the probability of developing anaemia (FIG. 15). The data suggested a direct sigmoid relationship between score and probability of anaemia. The model development was continued with an ROC analysis and a measurement of the area under the ROC on both the derivation and validation datasets. The findings suggested that the area under the ROC in both the internal and external validation samples were acceptable when compared to that derived from the derivation sample; 0.80 (95% CI: 0.74-0.85), 0.74 (95% CI: 0.66-0.82) vs. 0.86 (95% CI: 0.83-0.89), supporting the internal and external validity of the scoring system.

The final step in the development of the prediction tool was the identification of a risk score threshold, which maximized sensitivity and specificity and was able to minimize the misclassification rate. Four risk score categories were developed (Table 4). The analysis identified a risk score threshold of ≧8 to <10 as being the range where sensitivity and specificity are maximized and a high proportion (69.8%) of patients are correctly classified (Table 4). Using a risk score threshold between ≧8 to <10 would capture patients with a risk of anaemia of approximately 26%. Patients with scores of ≧8 would have an anaemia risk of greater than 26% (FIG. 15). Nonetheless, it is important to realize that these risk score thresholds are not fixed and can vary based on the patient or oncologist's risk tolerance. Some may prefer to select a higher risk threshold before the initiation of prophylactic agents such as recombinant erythropoietin. A higher risk such as ≧10 would have a higher specificity (89.7%), which would minimize the false positive rate (i.e. fewer people would receive prophylactic recombinant erythropoietin who actually did not need it). Based on our suggested risk threshold, the 70 year old women described earlier who was about to receive her first cycle of carboplatin-gemcitabine chemotherapy would be classified as “high risk” and would be a good candidate to initiate prophylactic erythropoietin treatment.

TABLE 4
Detailed analysis of risk scoring system for chemotherapy induced
anaemia.

| Score Cut | Anaemia | | | Correctly | Likelihood |
|---|---|---|---|---|---|
| Point | Incidence¹ | Sensitivity | Specificity | Classified | Ratio² |
| <6 | 0.42% | 100% | 0.0% | 13.3% | 1.0 |
| ≧6 to <8 | 5.5% | 99.3% | 24.6% | 34.6% | 1.32 |
| ≧8 to <10 | 26.2% | 83.1% | 67.8% | 69.8% | 2.58 |
| ≧10 | 32.6% | 32.4% | 89.7% | 82.1% | 3.16 |

¹As measured in the derivation sample. Patients with a risk score of ≧8 to <10 had an anaemia risk of approximately 26%. Patients with scores of ≧10 have anaemia risks greater than 26%. Therefore in our analysis, we considered an anaemia risk of ≧26% to be “high risk”.
²The ratio of the probability of a positive test result, in this case a risk score of at least ≧8 to <10, among patients who actually develop anaemia to the probability of a positive test result among patients who do not develop anaemia. Therefore, patients who truly developed anaemia were 2.58 times more likely than patients who did not develop anaemia to have a risk score of at least ≧8 to <10.

### Example 2

### The Development of a Prediction Tool for Chemotherapy-Induced Anaemia in Breast Cancer Patients Receiving Adjuvant Chemotherapy

### Methods

Patients: The medical records of 331 patients who received adjuvant breast cancer chemotherapy at the Toronto Sunnybrook Regional Cancer Centre from 2000 to 2003 were reviewed. The data collection consisted of patient demographic and disease related information, patient weight, body surface area (BSA) menopausal status, baseline, pre and post chemotherapy cycle Hb, white blood cells (WBC), absolute neutrophil count (ANC), platelets and the use of prophylactic antibiotics and G-CSF. Patients who received prophylactic epoetin alfa were excluded but patients who received transfusion support (3.9% overall) were included as this is the standard of care.

Chemotherapy Treatment: The intent of this example was to develop a prediction model that would be generalizable to a broad range of breast cancer patients receiving adjuvant chemotherapy. Therefore, chemotherapy was not limited to a single regimen, but consisted of a wide range of commonly used protocols as outlined in Table 5.

TABLE 5
Adjuvant chemotherapy protocols included in the sample of 331
patients

| | Cycles Delivered | |
|---|---|---|
| Chemotherapy Protocol | (n = 3255) | |
| CEF¹ or CAF (C given by mouth from day 1 to 14) | 71.9% | (2340)⁴ |
| CMF² | 12.3% | (401) |
| AC | 6.7% | (218) |
| MF | 5.9% | (192) |
| Other (FAC, FEC, FEC21, FEC100, AC-T)³ | 3.2% | (104) |

Abbreviations:
A = doxorubicin,
C = cyclophosphamide,
5-FU = 5 fluorouracil,
E = epirubicin,
M = methotrexate,
T = paclitaxel,
IV = intravenous,
PO = oral
¹CEF consists of IV treatment on day 1 and then day 8. Therefore, each cycle consists of 2 treatments and was therefore counted as 2 cycles for the analysis.
²C was administered via the oral route from days 1 to 14 in 11.7% (n = 381) of cycles. This CMF regimen consists of IV treatment on day 1 and then day 8. Therefore, each cycle consists of 2 treatments and was therefore counted as 2 cycles for the analysis. In the remainder (0.61%, n = 20), C was delivered on day 1 intravenously and contributed to a single cycle.
³In these protocols, C is typically given intravenously on day 1 of the cycle.
⁴The numbers within the brackets are the actual number of cycles for that particular chemotherapy protocol.

From the first cycle until the completion of chemotherapy, data collection included the dose of individual drugs, total number of cycles delivered, number of dose reductions and delays and total number of red blood cell units administered. As our primary endpoint, anaemia was defined as a blood Hb≦100 g/L following a cycle of chemotherapy. This target end point for anaemia was used because it is often used as a “trigger” for a blood transfusions and clinically, such a drop can have a major impact on patient quality of life (Cortesi E, et al. Oncology. 2005; 68 Suppl 1:22-32). With many of the chemotherapy regimens evaluation, intravenous treatment consisted of a day 1 and 8 administration. Since each cycle consists of 2 treatments (part a and b) with two measurements of blood biochemistry, it was counted as 2 cycles in the analysis. It is important to note that all cycles of adjuvant chemotherapy were completed if possible, even if it meant dose reductions, delays and the use of G-CSF.

Development of Prediction Model and Scoring System: To develop a cycle-based prediction model, the patient sample was randomly divided into a two-thirds derivation and one-third internal validation dataset. Patient demographic and clinical characteristics were presented descriptively as mean, medians or proportions. Before the full analysis was initiated, the relevant covariates for initial model inclusion were identified by a univariate screening process with a preset alpha=0.25. This approach has been recommended in the literature for removing unimportant covariates so that a more manageable set of variables can be submitted to multivariate techniques (George S L. Semin Oncol 1988; 15:462-71; Klastersky J, et al. J Clin Oncol. 2000; 18:3038-51). The individual odds ratio (OR) for anaemia from each of the remaining risk factors alone (post univariate screening) was then estimated. To determine the final predictive factors for retention into the model, multivariable logistic regression analysis adjusted for clustering on the patient was applied (Allison P D. Logistic Regression Using the SAS System: Theory and Application; Chapter 8; p 179-216. Cary, N.C.: SAS Institute Inc., 1999). This adjustment for clustering is required because observations between multiple cycles of chemotherapy within a given patient violate the independence assumption of logistic regression. If related observations are treated as independent, they usually produce standard errors that are underestimated and test statistics that are overestimated. The Likelihood ratio test was used in a backwards elimination process (P<0.05 to retain) to select the final covariates for retention into the model (Kleinbaum D G. Logistic Regression: A Self-Learning Text. New York, Springer, 1994). An evaluation of interaction effects between age and other variables failed to identify significant effects. The final risk factors were then given a statistical weight based on the regression model coefficients. A risk scoring system was then developed with a risk score ranging from 0 to 50. A risk score was assigned to each patient by adding up points for each risk factor they possessed.

Validation of Prediction Model: The predictive accuracy of the final model and risk scoring system was determined by measuring the specificity, sensitivity and area under the Receiver Operating Characteristic (ROC) curves in both the derivation and validation sample as described above in Example 1. In the current Example, two sets of validation were performed with an internal and external sample. The internal validation sample consisted of one-third of our original patient cohort (n=110) that had been randomly selected. The external validation sample consisted of adjuvant breast cancer patients randomized into the control arm of the multicentre open-label trial reported by Chang et al. (2004), which compared the impact of weekly epoetin alfa on transfusion requirements and quality of life (Chang J, et al. J Clin Oncol. 2005; 23:2597-605). This trial provided 119 patients who received 382 cycles of adjuvant chemotherapy. However, it is important to note that the majority of patients who participated in that trial were enrolled after the first cycle. Only 1.0% patients were chemotherapy naïve before trial entry and provided data from cycle 1. Therefore, the status of patient entry provided an opportunity to test the predictive accuracy of our model in patients at different points of their treatment. In addition, many baseline variables were not available in this external validation sample. However, this was not problematic because most of these missing variables were not required in the validation exercise. All of the statistical analyses were performed using Stata, release 8.0 (Stata Corp., College Station, Texas, USA).

### Results

The 221 patients in the derivation sample received 2200 cycles (complete data) of chemotherapy. Only 2.6% of patients were anaemic at the start of the study. By the final cycle of chemotherapy, 24.9% (55) of patients became anaemic, defined as a blood Hb less than or equal to 100 g/L. Patients from the model derivation and internal validation datasets were comparable with respect to demographic and disease and biochemical characteristics as shown in Table 6. However, differences were noted between the derivation sample and external validation sample with respect to baseline Hb, baseline platelets, type of adjuvant chemotherapy and chemotherapy doses received. The use of the more myelosuppresive CAF (cyclophosphamide, doxorubicin, 5-fluorouracil) and CEF (cyclophosphamide, epiribicin, 5-fluorouracil) protocols was greater in the derivation than both the internal and external validation sample (66.1% vs. 61.8% vs. 49.5%). In addition, a lower proportion of patients in the external validation sample received an anthracycline dose>85 mg (total dose) than in both the internal validation samples (see Table 6). Notwithstanding, it is important to recall that this is not a randomized trial, but an exercise to develop an anaemia prediction model from unique patient samples. Therefore, imbalance between validation and derivation samples should be expected and even encouraged to ensure that the prediction model can be applied to variety of breast cancer patients at any cycle of chemotherapy.

TABLE 6
Characteristics of patients in the derivation and validations samples.

| | | |
|---|---|---|
| | Internal | External |
| Derivation | Validation | Validation |
| (n = 221) | (n = 110) | (n = 119) |

| Characteristic | | | | | | |
|---|---|---|---|---|---|---|
| Mean age (range) | 49.9 | (27-75) | 50.6 | (28-72) | 49.0 | (31-76) |
| Mean BSA [m²]¹ | 1.7 | (0.18) | 1.7 | (0.17) | N/A | |
| Mean tumour size [cm]¹ | 2.8 | (1.8) | 1.5 | (2.0) | N/A | |
| Median number of nodes (range) | 1 | (0-23) | 1 | (0-23) | N/A | |
| Tumour Grade (n)² | | | | | | |
| Low | 9.5% | (21) | 10.0% | (11) | N/A | |
| Intermediate | 38.5% | (85) | 36.4% | (40) | N/A | |
| High | 48.9% | (108) | 49.1% | (54) | N/A | |
| Missing data | 3.2% | (7) | 4.5% | (5) | N/A | |
| Histology (n)² | | | | | | |
| Ductal | 91.0% | (201) | 88.2% | (97) | N/A | |
| Lobular | 7.7% | (17) | 7.3% | (8) | N/A | |
| Inflammatory | 0.90% | (2) | 2.7% | (3) | N/A | |
| Missing data | 0.45 | (1) | 1.8% | (2) | N/A | |
| ER positive | 65.2% | (144) | 65.4% | (72) | 58.8% | (70) |
| ER negative | 33.5% | (74) | 29.1% | (32) | 39.5% | (47) |
| ER status unknown | 1.4% | (3) | 5.5% | (6) | 1.7% | (2) |
| PR positive | 55.0% | (121) | 55.5% | (61) | N/A | |
| PR negative | 43.4% | (96) | 40.9% | (45) | N/A | |
| PR status unknown | 1.4% | (3) | 3.6% | (4) | N/A | |
| HER2 positive | 10.5% | (18)³ | 16.5% | (14)³ | N/A | |
| Post menopausal | 38.4% | (85) | 45.4% | (50) | 37.0% | (44) |
| Pre menopausal | 51.6% | (114) | 43.6% | (48) | 61.3% | (73)⁴ |
| Peri menopausal | 6.3% | (14) | 4.5% | (5) | N/A | |
| Missing data | 3.6% | (8) | 6.4% | (7) | 1.7% | (2) |
| Mean baseline Hb [g/L]¹ | 132 | (11.8) | 132 | (10.8) | 113.7 | (6.76) |
| Mean baseline WBC [×10⁹ cells/l]¹ | 6.9 | (2.2) | 6.6 | (2.1) | N/A | |
| Mean baseline ANC [×10⁹ cells/l]¹ | 4.2 | (1.8) | 3.9 | (1.8) | N/A | |
| Mean baseline platelets [×10⁹ cells/l]¹ | 274 | (73) | 272 | (67) | 321 | (105) |
| Prophylactic oral antibiotics at the | 5.5% | (12) | 14.5% | (16) | N/A | |
| start of cycle 1 | | | | | | |
| Adjuvant Chemotherapy at Cycle 1 | | | | | | |
| CMF, MF, AC | 30.8% | (68) | 35.4% | (39) | 22.7% | (27) |
| CAF, CEF | 66.1% | (146) | 61.8% | (68) | 49.5% | (59) |
| Other (FAC, FEC21, FEC100, | 3.2% | (7) | 2.7% | (3) | 27.7% | (33) |
| AC-T) | | | | | | |
| At the start of Chemotherapy⁵ | | | | | | |
| C dose ≧875 mg | 50.0% | (111) | 50.0% | (55) | 77.3% | (92) |
| 5-FU dose ≧400 mg | 42.5% | (94) | 36.4% | (40) | 73.1% | (87) |
| Anthracycline dose >85 mg | 76.9% | (170) | 81.8% | (90) | 65.5% | (78) |

Abbreviations:
A = doxorubicin,
C = cyclophosphamide,
5-FU = 5 fluorouracil,
E = epirubicin,
M = methotrexate,
T = paclitaxel,
BSA = body surface area,
N/A = data not available.
Hb = hemoglobin,
WBC = white blood count,
ANC = absolute neutrophil count.
¹Variance measure in round brackets refers to standard deviation.
²Using the number of patients as the demoninator.
³Data on HER2 (positive, negative, unknown) status was only available on 172 patients in the derivation sample and 85 patients in the internal validation sample.
⁴Pre and peri menopausal status was not differentiated in the randomized trial.
⁵Total dose.

After the initial univariate screening (with a P<0.25) removed the unimportant covariates, the direction and magnitude of anaemia risk were measured as an odds ratio (OR) for each of the remaining variables individually. The variables with the strongest association with anaemia were pre cycle Hb, WBC and platelets, cycle number, inflammatory histology and CAF or CEF chemotherapy (Table 7). The OR for pre cycle Hb warrants interpretation. The OR for Hb was 1.26, which suggests that for every 1 g/L drop in pre cycle Hb, the relative risk of developing anaemia following that particular cycle of chemotherapy is increased by 26% (Table 7).

TABLE 7
Assessment of individual factors on the risk of anaemia in the derivation
cohort

| | Odds | | |
|---|---|---|---|
| | ratio | 95% CI | P-Value |
| Risk Factor¹ | | | |
| Age < 65 years | 3.48 | 0.96-12.5 | 0.057 |
| Pre Cycle Hb | 1.26 | 1.23-1.30 | <0.001 |
| Pre Cycle WBC ≦3.5 (×10⁹ cells/l) | 3.24 | 224-4.70 | <0.001 |
| Platelets ≦200 (×10⁹ cells/l) | 1.86 | 1.33-2.61 | <0.001 |
| Cycle number | 1.15 | 1.10-1.21 | <0.001 |
| Histology (vs. ductal) | | | |
| Lobular | 0.90 | 0.44-1.83 | 0.77 |
| Inflammatory | 3.43 | 2.58-4.58 | <0.001 |
| HER2 positive (vs. negative or unknown) | 1.65 | 0.80-3.41 | 0.18 |
| Anthracycline dose >85 mg | 1.56 | 0.97-2.50 | 0.064 |
| Chemo Category (vs. CMF, AC, MF) | | | |
| CAF/CEF | 14.2 | 5.41-37.30 | <0.001 |
| FAC/FEC21/FEC100/AC-T | 5.0 | 0.54-45.7 | 0.16 |
| Ciprofloxacin prophylaxis (vs. none) | 1.73 | 1.07-1.82 | 0.025 |
| Trimethoprim-sulfamethoxazole | 1.28 | 0.90-1.85 | 0.17 |
| prophylaxis (vs. none) | | | |

Abbreviations:
A = doxorubicin,
C = cyclophosphamide,
5-FU = 5 fluorouracil,
E = epirubicin,
M = methotrexate,
T = paclitaxel
¹These were the variables retained after the initial univariate screening process. Chemotherapy from the first to the final cycle was included in the analysis.

The development of the prediction model was then continued with the multivariable logistic regression analysis using the Likelihood ratio test in a backwards elimination process for final variable selection (P<0.05 to retain). The final variables retained in the model were pre cycle Hb, cycle number, patient age, low platelets (≦200 ^{x} 10⁹ cells/l), type of chemotherapy and the use of prophylactic antibiotics (Table 8). The variables identified as being important predictive factors for anaemia were age≧65 yrs, lower platelets (≦200 [^{x} 10⁹ cells/l) and type of chemotherapy (CAF and CEF being to most myelotoxic). As expected, pre cycle Hb was an important predictor of anaemia where a 1 g/L drop was associated with a 29% relative risk increase.

TABLE 8
Final anaemia prediction model developed from the derivation dataset.

| | Odds Ratio | | Impact |
|---|---|---|---|
| | (95% CI) | P-value² | on Anaemia Risk |
| Variable | | | |
| Pre Cycle Hb | 1.29 (1.25-1.33) | <0.001 | Increased by 29% |
| | | | per 1 g/L drop |
| Cycle (1-12) | 0.95 (0.89-1.02) | 0.13 | Risk not constant |
| | | | between cycles³ |
| Age ≧ 65 yrs¹ | 4.70 (2.01-11.0) | <0.001 | 4.7 times |
| Pre Platelets ≦200 ^{×} | 1.53 (0.98-2.41) | 0.059 | Increased 53% |
| 10⁹ cells/l | | | |
| Prophylactic | 0.55 (0.27-1.31) | 0.10 | Trend for reduced |
| Antibiotics | | | risk |
| Type of Chemo | | | |
| (vs. CMF, AC, MF) | 4.4 (2.11-9.42) | <0.001 | Increased |
| CEF/CAF | | | 4.4 times |
| FAC/CEF21/FEC100/ | 1.81 (0.23-14.0) | 0.57 | Increased |
| AC-T | | | 1.8 times |

Abbreviations:
A = doxorubicin,
C = cyclophosphamide,
5-FU = 5 fluorouracil,
E = epirubicin,
M = methotrexate,
T = paclitaxel
¹It is important to note compared to Table 3, the direction of the odds ratio for age in this adjusted analysis was reversed where older people were associated with a higher risk. This reversal in the odds ratio occurred because the odds ratio for age was adjusted for differences in prechemotherapy Hb levels between the older and younger patients.
²The P-value is generated from the Wald test, which is standard output in most statistical packages. However, the Likelihood ratio (LR) test in a backwards elimination process was used to retain or reject variables. In the case of cycle, platelets and prophylactic antibiotics, the LR test failed to eliminate these variables (using a cut off of p < 0.05).
³Following the application of the LR-test, cycle number had to be retained because our model was duration dependent and the hazard function (i.e. risk for anaemia) was not constant from cycle 1 until the completion of chemotherapy.

Even though the p-value for the OR of cycle number (obtained from the Wald Test) did not reach statistical significance, the variable had to be retained because our model was duration dependent and the hazard function (i.e. risk for anaemia) was not constant from cycle 1 until the completion of chemotherapy (Table 8). Furthermore, the Likelihood ratio test applied to the model in a backwards elimination process failed to eliminate cycle number (as well as platelets and prophylactic antibiotics) from the model. The use of prophylactic antibiotics after adjusting for pre cycle Hb was associated with a lower risk of anaemia (Table 8).

A risk scoring system was then developed from the point estimates of the regression coefficients and the intercept generated from the analysis. Each of the final regression coefficients retained in the model provided a statistical weight for that factor's contribution to the overall risk of anaemia. The scoring system was then adjusted by adding a constant across all scores to ensure that none were below zero. The final product was a scoring system between 0 and 50 where higher scores were associated with an elevated risk. The starting point and score assigned to each of the predictive factors is as follows:
Start at an initial score of 50.
Take ¼ of precycle Hb and subtract from 50.
If the patient has received at least one cycle of chemotherapy, subtract 1
If the patient z 65 yrs, add 2
Platelets≦200 [^{x} 10⁹ cells/l, add 1
If currently taking prophylactic antibiotics, subtract 1
If the patient is about to receive CEF or CAF chemotherapy, add 2
If the patient is about to receive CEF'21, CAF, FEC100, AC-T chemotherapy, add 1

Factors that add to the overall score are considered to be positive risk factors. For instance, age beyond 65 years requires the addition of 2 units and is thus a risk factor for the development of anaemia. As an illustration, imagine a 70-year old lady with a baseline Hb of 115, normal platelets who is about to undergo her first cycle of CEF, her risk score prior to the first cycle of chemotherapy would be 25.25.

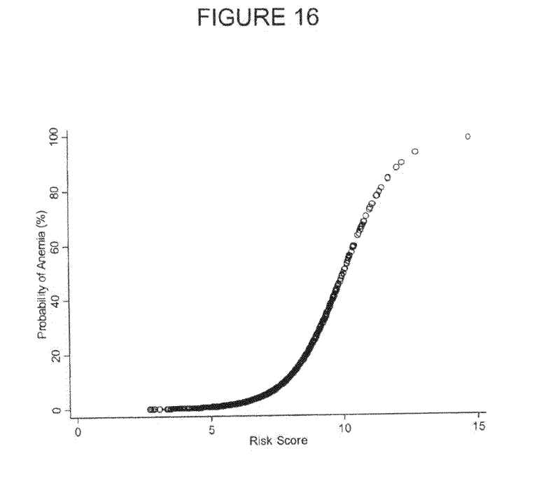

The final phase of the current study was to evaluate the accuracy of the prediction tool and to determine the score that would classify patients as “high risk”. Patient within each of the three datasets were assigned a risk score based on the above system. The risk score in the derivation dataset was then compared to the probability of developing anaemia (see FIG. 16). The data suggested a direct sigmoid relationship between score and probability of anaemia. The model development was continued with an ROC analysis and a measurement of the area under the ROC on both the derivation and validation datasets. The findings suggested that the area under the ROC in both the internal and external validation samples were acceptable when compared to that derived from the derivation sample; 0.88 (95% CI: 0.86-0.91), 0.84 (95% CI: 0.80-0.88) vs. 0.95 (95% CI: 0.94-0.96), supporting the internal and external validity of the scoring system.

The final step in the development of the prediction tool was the identification of a risk score threshold, which maximized sensitivity and specificity and was able to minimize the misclassification rate. Seven risk score categories were developed as shown in Table 5. The analysis identified a risk score threshold of ≧24 to <25 as being the range where sensitivity and specificity are maximized and a high proportion (91%) of patients are correctly classified (Table 9). Using a risk score threshold between ≧24 to <25 would capture patients with a risk of anaemia of approximately 40%. Patients with scores of ≧25 would have an anaemia risk of greater than 40% (see FIG. 16). Nonetheless, it is important to realize that these risk score thresholds are not fixed and can vary based on the patient or oncologist's risk tolerance. Some may prefer to select a higher risk threshold before the initiation of prophylactic agents such as epoetin alfa. A higher risk such as ≧25 to <26 would have a higher specificity (96.4%), which would minimize the false positive rate (i.e. fewer people would receive prophylactic colony stimulating factors who actually did not need it). Based on our suggested risk threshold, the 70 year old lady described earlier who was about to receive her first of CEF would be classified as “high risk” and would be a good candidate to initiate prophylactic epoetin alfa.

TABLE 9
Detailed analysis of risk scoring system for chemotherapy induced
anaemia.

| Score Cut | Anaemia | | | Correctly | Likelihood |
|---|---|---|---|---|---|
| Point | Incidence¹ | Sensitivity | Specificity | Classified | Ratio² |
| ≦21 | 0.4% | 100% | 0.0% | 14.9% | 1.0 |
| >21 to <23 | 2.8% | 98.8% | 60.4% | 66.1% | 2.9 |
| ≧23 to <24 | 20.6% | 94.8% | 84.7% | 86.2% | 6.2 |
| ≧24 to <25 | 40.3% | 83.5% | 92.3% | 91.0% | 10.8 |
| ≧25 to <26 | 63.0% | 67.7% | 96.4% | 92.1% | 18.9 |
| ≧26 to <27 | 82.7% | 48.5% | 98.4% | 91.0% | 30.2 |
| ≧27 | 85.1% | 29.6% | 99.1% | 88.7% | 32.5 |

¹As measured in the derivation sample. Patients with a risk score of ≧24 to <25 had an anaemia risk of approximately 40%. Patients with scores of ≧25 have anaemia risks greater than 40%. Therefore in our analysis, we considered anaemia risk of ≧40% to be “high risk”.
²The ratio of the probability of a positive test result, in this case a risk score of at least ≧24 to <25, among patients who actually develop anaemia to the probability of a positive test result among patients who do not develop anaemia. Therefore, patients with a positive test result (i.e. a risk score of at least ≧24 to <25) are 10.8 times more likely to develop anaemia according to our scoring system.

### Example 3

### Mathematization of Risk and Benefit for First-Line Treatment of Metastatic Colorectal Cancer: A Graphical Decision Aid for Patients and Physicians

### Methods

A literature review was carried out searching for trials of chemotherapeutic regimens for the first-line treatment of unresectable metastatic colorectal cancer. The most recent, largest, most advanced phase (III vs. II) trials were taken as representative. If several trials were available, all were reported.

Benefits were median overall survival in months (OS) and progression-free survival/TTP in months (PFS).

Toxicities were determined as the percent (%) of all analysed/reported patients experiencing the toxicity during the course of the trial. Toxicities assessed were: diarrhoea (Grade 3+4, “severe”), mucositis (Grade 3+4, “severe”), neurological and cutaneous (excluding alopecia) (Grade 3+4, “severe”), vomiting (Grade 3+4, “severe”) or nausea/vomiting or nausea if no vomiting reported, febrile neutropenia (FN) or grade 3 & 4 infection if FN not reported specifically, toxic death rate (treatment related mortality) or 60-day mortality if not otherwise reported.

Toxicity Sum was calculated as the sum of the above toxicities for a given regimen.

Benefit Toxicity Ratios=OS/Toxicity Sum or PFS/Toxicity Sum

### Results

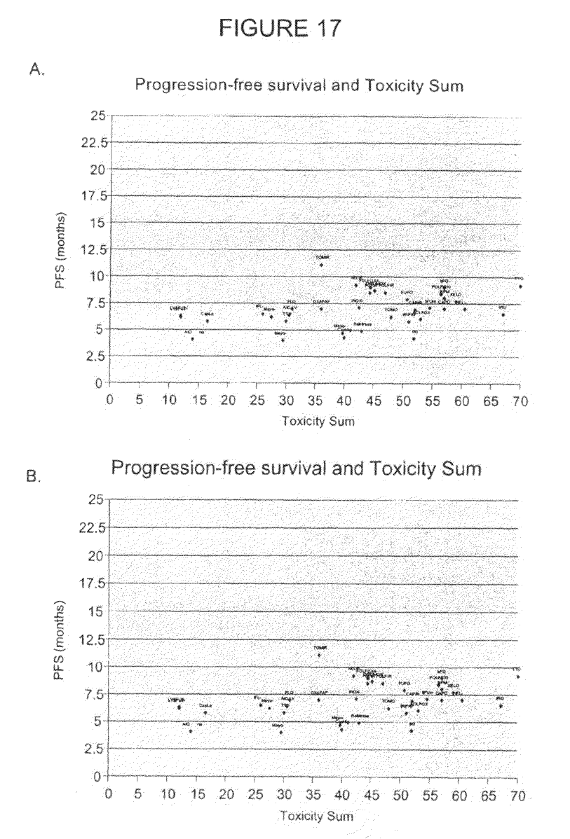

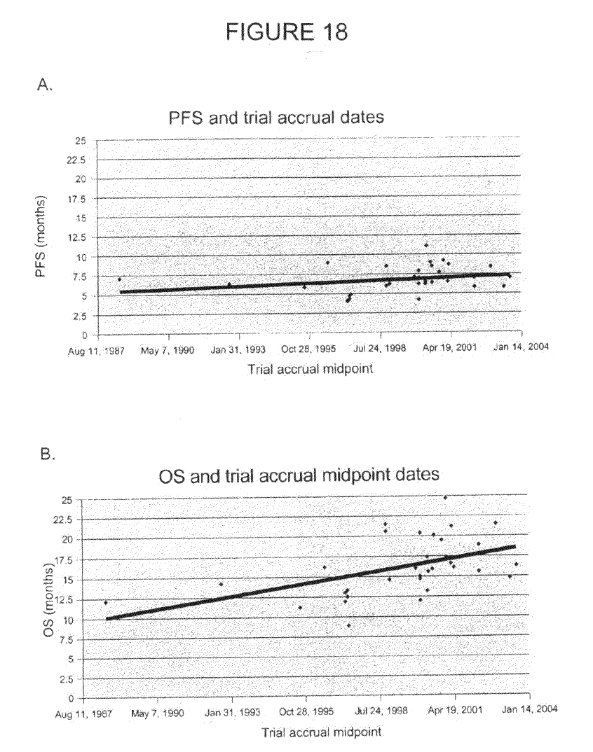

Thirty-two regimens found for which phase II/III studies were available with toxicity data (either published or via personal communication from principal investigators) (see Table 10). FIGS. 17A and B show a plot of OS and PFS, respectively, against the regimen's reported Toxicity Sum (TS). A greater variation was observed in overall survival than in progression free survival (see FIGS. 18A and B).

Graphs such as these can be provided as handouts to patients during discussions and/or used as an education tool for physicians and patients as they emphasize the balanced presentation of treatment options. Similar analysis can be conducted on other tumour sites and/or newer biological agents.

TABLE 10
Results

| | | | | OS | PFS | | OS/ | PFS/ |
|---|---|---|---|---|---|---|---|---|
| Reference | Description | N | Name | (mos) | (mos) | TS | TS | TS |
| 1 | — | 391 | BSC | 8 | | 0 | | |
| 2 | Raltitrexed | 301 | Raltitrexed | 8.9 | 4.9 | 43 | 0.21 | 0.11 |
| | 3 mg/m² q 21 days | | | | | | | |
| 3 | 5FU 3500 mg/m² | 155 | TTD | 11.2 | 5.83 | 30 | 0.37 | 0.19 |
| | over 48 h × 6/8 | | | | | | | |
| | weeks | | | | | | | |
| 4 | 5FU bolus 425 mg/m² | 167 | Mayo-2003 | 11.9 | 4 | 29.5 | 0.40 | 0.14 |
| | and LV | | | | | | | |
| | bolus 20 mg/m² | | | | | | | |
| | days 1-5 q 4 wks | | | | | | | |
| 5 | Irinotecan 125 mg/m² | 226 | IRI | 12 | 4.2 | 51.9 | 0.23 | 0.08 |
| | q wk × 4/6 | | | | | | | |
| | weeks | | | | | | | |
| 6 | 5FU infusion 200-750 mg/m²/ | 607 | 5FUinf | 12.1 | 7.1 | 54.5 | 0.22 | 0.13 |
| | day | | | | | | | |
| 7 | Capecitabine 1250 mg/m² | 302 | CapHigh | 12.5 | 4.3 | 40 | 0.31 | 0.11 |
| | bid × 14/21 | | | | | | | |
| | days | | | | | | | |
| 8 | 5FU 600 mg/m² | 109 | RPMI | 12.8 | 8 | 57 | 0.22 | 0.14 |
| | and LV 500 mg/m2 | | | | | | | |
| | bolus | | | | | | | |
| | weekly × 6/8 | | | | | | | |
| | weeks | | | | | | | |
| 9 | FU 2600 mg/m² × | 166 | AIO no LV | 13 | 4.1 | 14 | 0.93 | 0.29 |
| | 24 hrs q weekly × | | | | | | | |
| | 6/8. | | | | | | | |
| 10 | 5FU bolus 425 mg/m² | 216 | Mayo-1997 | 13.2 | 6.2 | 27.5 | 0.48 | 0.23 |
| | and LV | | | | | | | |
| | bolus 20 mg/m² | | | | | | | |
| | days 1-5 q 4 wks | | | | | | | |
| 11 | 5FU bolus 425 mg/m² | 303 | Mayo-2001 | 13.3 | 4.7 | 39.7 | 0.34 | 0.12 |
| | and LV | | | | | | | |
| | bolus 20 mb/mg/m² | | | | | | | |
| | 1-5 q 4 wks | | | | | | | |
| 12 | FU bolus 4--mg/m² | 208 | LV5FU2- | 14.23 | 6.33 | 12 | 1.19 | 0.53 |
| | and | | 1997 | | | | | |
| | infusion of 600 mg/m² × | | | | | | | |
| | 22 hrs, | | | | | | | |
| | LV 200 mg/m² | | | | | | | |
| | over 2 hrs d 1 + 2, | | | | | | | |
| | all q 14 days | | | | | | | |
| 13 | Raltitrexed 3 mg/m² | 71 | TOMOX | 14.6 | 6.2 | 48 | 0.30 | 0.13 |
| | q 21 days | | | | | | | |
| | plus oxaliplatin | | | | | | | |
| | 130 mg/m² | | | | | | | |
| 14 | FU bolus 400 mg/m² | 210 | LV5FU2- | 14.7 | 6.2 | 12 | 1.23 | 0.52 |
| | and | | 2000 | | | | | |
| | infusion of 600 mg/m² × | | | | | | | |
| | 22 hrs, | | | | | | | |
| | LV 200 mg/m² | | | | | | | |
| | over 2 hrs 2 1 + 2, | | | | | | | |
| | all q 14 days | | | | | | | |
| 15 | Capecitabine 1000 mg/m² | 221 | CapLow | 14.8 | 5.8 | 16.5 | 0.90 | 0.35 |
| | bid × 14/21 | | | | | | | |
| | days | | | | | | | |
| 16 | Irinotecan 125 mg/m² | 255 | IFL-2000 | 15 | 7 | 60.5 | 0.25 | 0.12 |
| | and bolus | | | | | | | |
| | FU 500 mg/m² | | | | | | | |
| | plus LV 20 mg/m² | | | | | | | |
| | on days 1, 8, 15, | | | | | | | |
| | and 22 q 6 weeks. | | | | | | | |
| 17 | Irinotecan 200 mg/m² | 136 | IRIFAFU | 15.6 | 5.8 | 51 | 0.31 | 0.11 |
| | day 1, LV | | | | | | | |
| | 250 mg/m² and | | | | | | | |
| | 5FU 850 mg/m² | | | | | | | |
| | day 2, q 14 days. | | | | | | | |
| 18 | Raltitrexed 3 mg/m² | 91 | TOMIRI | 15.6 | 11.1 | 36 | 0.43 | 0.31 |
| | q 21 days | | | | | | | |
| | plus irinotecan | | | | | | | |
| | 350 mg/m² | | | | | | | |
| 19 | Oxaliplatin 85 mg/m² | 42 | bFOL | 15.9 | 9 | 57 | 0.28 | 0.16 |
| | d1 & d15 | | | | | | | |
| | with LV 20 mg/m² | | | | | | | |
| | and 5FU 500 mg/m² | | | | | | | |
| | weekly × | | | | | | | |
| | 3/4 weeks | | | | | | | |
| 20 | Irinotecan 150-175 mg/m² | 46 | IROX-low | 16 | 7.1 | 42.5 | 0.38 | 0.17 |
| | and | | | | | | | |
| | oxaliplatin 85 mg/m² | | | | | | | |
| | q 21 days | | | | | | | |
| 21 | FU 500 mg/m² and | 85 | FLOX | 16.1 | 7 | 31 | 0.52 | 0.23 |
| | LV 60 mg/m² | | | | | | | |
| | bolus days 1 and 2 | | | | | | | |
| | q 14 days, with | | | | | | | |
| | oxaliplatin 85 mg/m² | | | | | | | |
| | day 1 | | | | | | | |
| 22 | FU bolus 400 mg/m² | 210 | FOLFOX4- | 16.2 | 9 | 44.5 | 0.36 | 0.20 |
| | and | | 2000 | | | | | |
| | infusion of 600 mg/m² × | | | | | | | |
| | 22 hrs, | | | | | | | |
| | LV 200 mg/m² | | | | | | | |
| | over 2 hrs d 1 + 2 | | | | | | | |
| | all q 14 days with | | | | | | | |
| | oxaliplatin 85 mg/m² | | | | | | | |
| | day 1 | | | | | | | |
| 23 | Capecitabine 1000 mg/m² | 235 | CAPOX | 16.3 | 7 | 57 | 0.29 | 0.12 |
| | bid d1-14, | | | | | | | |
| | oxaliplatin 70 mg/m² | | | | | | | |
| | d1 and 8; | | | | | | | |
| | q 3 wks | | | | | | | |
| 24 | Irinotecan 125 mg/m² | 138 | IFL-2004 | 16.6 | 6.5 | 26 | 0.64 | 0.25 |
| | and bolus | | | | | | | |
| | FU 500 mg/m² | | | | | | | |
| | plus LV 20 mg/m² | | | | | | | |
| | on days 1, 8, 15, | | | | | | | |
| | and 22 q 6 weeks | | | | | | | |
| 25 | FU 2600 mg/m² × | 216 | AIO LV | 16.9 | 6.4 | 30.5 | 0.55 | 0.21 |
| | 24 hrs q weekly × | | | | | | | |
| | 6/8, plus 500 mg/m² | | | | | | | |
| | LV each | | | | | | | |
| | dose | | | | | | | |
| 26 | Weekly irinotecan | 36 | TTD-IRI | 17.2 | 9.2 | 70 | 0.25 | 0.13 |
| | 80 mg/m² with | | | | | | | |
| | 5FU 2250 mg/m² | | | | | | | |
| | over 48 h × 6/8 | | | | | | | |
| | weeks | | | | | | | |
| 27 | Capecitabine 1000 mg/m² | 38 | CAPIRI | 17.4 | 6.9 | 52 | 0.33 | 0.13 |
| | bid × 14/21 | | | | | | | |
| | days with CPT11 | | | | | | | |
| | 70 mg/m² weekly | | | | | | | |
| 28 | Irinotecan 200 mg/m² | 256 | IROX | 17.4 | 6.5 | 67.1 | 0.26 | 0.10 |
| | and | | | | | | | |
| | oxaliplatin 85 mg/m² | | | | | | | |
| | q 21 days | | | | | | | |
| 29 | 85-100 mg/m² | 140 | OXAFAFU | 18.9 | 7 | 36 | 0.53 | 0.19 |
| | oxaliplatin day 1, | | | | | | | |
| | LV 250 mg/m² and | | | | | | | |
| | 5FU 850-1050 mg/m² | | | | | | | |
| | day 2, q 14 | | | | | | | |
| | days. | | | | | | | |
| 30 | Oxaliplatin 130 mg/m² | 96 | XELOX | 19.5 | 7.7 | 59 | 0.33 | 0.13 |
| | (day 1) | | | | | | | |
| | followed by oral | | | | | | | |
| | capecitabine 1,000 mg/m² | | | | | | | |
| | twice daily | | | | | | | |
| | (day 1, evening, to | | | | | | | |
| | day 15, morning) | | | | | | | |
| 31 | FU 2000-2300 mg/m² × | 214 | FUFIRI | 20.1 | 8.5 | 44.4 | 0.45 | 0.19 |
| | 24 hrs q | | | | | | | |
| | weekly × 6/8, plus | | | | | | | |
| | 500 mg/m² LV | | | | | | | |
| | each dose, plus | | | | | | | |
| | irinotecan 80 mg/m² | | | | | | | |
| 32 | 5-fluorouracil | 118 | FUFOX | 20.4 | 7.9 | 50.7 | 0.40 | 0.16 |
| | 2000 mg/m² 24 h | | | | | | | |
| | infusion, folinic | | | | | | | |
| | acid 500 mg/m^{2,} | | | | | | | |
| | oxaliplatin 50 mg/m² | | | | | | | |
| | d1, 8, 15, 22; | | | | | | | |
| | q5 weeks | | | | | | | |
| 33 | FU 2400-3000 mg/m² × | 111 | FULFOX6 | 20.6 | 6 | 53 | 0.39 | 0.11 |
| | 46 hrs | | | | | | | |
| | plus bolus 400 mg/m², | | | | | | | |
| | LV 200 mg/m² | | | | | | | |
| | over 2 hrs, | | | | | | | |
| | all q 14 days, with | | | | | | | |
| | oxaliplatin 100 mg/m² | | | | | | | |
| | day 1 | | | | | | | |
| 34 | FOLFOX7 × 6 cy | 309 | OPTIMOX1 | 21.2 | 8.7 | 45.2 | 0.47 | 0.19 |
| | (ox 130 mg/m² d1, | | | | | | | |
| | LV 400 mg/m², | | | | | | | |
| | 5FU 46 h 2.4 g/m², | | | | | | | |
| | q 2w) followed by | | | | | | | |
| | sLV5FU 2 × 12 cy | | | | | | | |
| | (LV 400 mg/m², | | | | | | | |
| | 5FU bolus 400 mg/m² | | | | | | | |
| | d1 and 46-h | | | | | | | |
| | infusion 2.4 g/m², | | | | | | | |
| | q2w) then | | | | | | | |
| | FOLFOX7 | | | | | | | |
| | reintroduction | | | | | | | |
| 35 | FU 2400-3000 mg/m² × | 109 | FOLFIRI | 21.5 | 8.5 | 47 | 0.46 | 0.18 |
| | 46 hrs | | | | | | | |
| | plus bolus 400 mg/m², | | | | | | | |
| | LV 200 mg/m² | | | | | | | |
| | over 2 hrs, | | | | | | | |
| | all q 14 days, with | | | | | | | |
| | irinotecan 100 mg/m² | | | | | | | |
| | day 1 | | | | | | | |
| 36 | FU bolus 400 mg/m² | 137 | FOLFOXIRI | 21.5 | 8.4 | 56.46 | 0.38 | 0.15 |
| | and | | | | | | | |
| | infusion of 600 mg/m² × | | | | | | | |
| | 22 hrs | | | | | | | |
| | day 2 + 3; LV 200 mg/m² | | | | | | | |
| | over 2 hrs | | | | | | | |
| | day 2 + 3, all q14 | | | | | | | |
| | days, with | | | | | | | |
| | irinotecan 150 mg/m² | | | | | | | |
| | day 1, and | | | | | | | |
| | oxaliplatin 65 mg/m² | | | | | | | |
| | day 2 | | | | | | | |
| 37 | Capecitabine 1000 mg/m² | 37 | XELIRI | 24.7 | 9.2 | 42 | 0.59 | 0.22 |
| | bid × 14/21 | | | | | | | |
| | days with CPT11 | | | | | | | |
| | 300 mg/m² and | | | | | | | |
| | 240 mg/m² q 3wks | | | | | | | |
| | alternating | | | | | | | |

1. Palliative chemotherapy for advanced colorectal cancer: systematic review and meta-analysis. Simmonds PC BM J 2000 Sep 2; 321 (7260): 531-5
2. Comparison of survival, palliation, and quality of life with three chemotherapy regimens in metastatic colorectal cancer: a multicentre randomised trial. Maughan TS, James RD, Kerr DJ et al, Lancet 2002, 359: 1555-63
3. Randomized trial comparing monthly low-dose leucovorin and fluorouracil bolus with weekly high-dose 48-hour continuous-infusion fluorouracil for advanced colorectal cancer: A Spanish Cooperative Group for Gastrointestinal Tumor Therapy (TTD) study. Aranda E, Diaz-Rubio E. Cervantes A, et al. Annals of Oncology 9: 727-731, 1998
4. Randomized Phase III Study of High-Dose Fluorouracil Given As a Weekly 24-Hour Infusion With or Without Leucovorin Versus Bolus Fluorouracil Plus Leucovorin in Advanced Colorectal Cancer: European Organization of Research and Treatment of Cancer Gastrointestinal Group Study 40952. Kohne C-H, Wils J, Lorenz M et al, J Clin Oncol 21: 3721-3728, 2003
5. Irinotecan plus Fluorouracil and Leucovorin for Metastatic Colorectal Cancer. Saltz LB, Cox JV, Blanke C et al. NEJM 343: 905-914
6. Toxicity of Fluorouracil in Patients With Advanced Colorectal Cancer: Effect of Administration Schedule and Prognostic Factors. Meta-Analysis Group in Cancer, J Clin Oncol 16: 3537-3541
7. Comparison of Oral Capecitabine Versus Intravenous Fluorouracil Plus Leucovorin as First-Line Treatment in 605 Patients With Metastatic Colorectal Cancer: Results of a Randomized Phase III Study. Hoff PM, Ansari R, Batist G et al, J Clin Oncol 19: 2282-2292, 2001
8. The Modulation of Fluorouracil With Leucovorin in Metastatic Colorectal Carcinoma: A Prospective Randomized Phase III Trial. Petrelli N, Douglass HO, Herrera L et al, J Clin Oncol 7: 1419-1426, 1989
9. Randomized Phase III Study of High-Dose Fluorouracil Given As a Weekly 24-Hour Infusion With or Without Leucovorin Versus Bolus Fluorouracil Plus Leucovorin in Advanced Colorectal Cancer: European Organization of Research and Treatment of Cancer Gastrointestinal Group Study 40952. Kohne C-H, Wils J, Lorenz M et al, J Clin Oncol 21: 3721-3728, 2003
10. Randomized Trial Comparing Monthly Low-Dose Leucovorin and Fluorouracil Bolus with Bimonthly High-Dose Leucovorin and Fluorouracil Bolus Plus Continuous Infusion For Advanced Colorectal Cancer: A French Intergroup Study. DeGramont A, Bosset J-F, Milan C et al, J Clin Oncol 15: 808-815
11. Comparison of Oral Capecitabine Versus Intravenous Fluorouracil Plus Leucovorin as First-Line Treatment in 605 Patients With Metastatic Colorectal Cancer: Results of a Randomized Phase III Study. Hoff PM, Ansari R, Batist G et al, J Clin Oncol 19: 2282-2292, 2001
12. Randomized Trial Comparing Monthly Low-Dose Leucovorin and Fluorouracil Bolus with Bimonthly High-Dose Leucovorin and Fluorouracil Bolus Plus Continuous Infusion For Advanced Colorectal Cancer: A French Intergroup Study. DeGramont A, Bosset J-F, Milan C et al, J Clin Oncol 15: 808-815
13. Multicentre non-randomized phase II study of raltitrexed (Tomudex) and oxaliplatin in non-pretreated metastatic colorectal cancer patients. Seitz J-F, Bennouna J, Paillot B et al. Ann Oncol 13: 1072-1079, 2002
14. Leucovorin and Fluorouracil With or Without Oxaliplatin as First-Line Treatment in Advanced Colorectal Cancer, DeGramont A, Figer A, Seymour M et al. J Clin Oncol 18: 2938-2947, 2000
15. Dose reduced first-line capecitabine monotherapy in older and less fit patients with advanced colorectal cancer. Vincent N, Jonker D, Kerr I et al. Proc Am Soc Onc 2005
16. A Randomized Controlled Trial of Fluorouracil Plus Leucovorin, Irinotecan, and Oxaliplatin Combinations in Patients With Previously Untreated Metastatic Colorectal Cancer. Goldberg R, Sargent D, Morton R et al J Clin Oncol 22: 23-30
17. Oxaliplatin plus high-dose folinic acid and 5-fluorouracil i.v. bolus (OXAFAFU) versus irinotecan plus high-dose folinoc acid and 5-fluorouracil i.v. bolus (IRIFAFU) in patients with metastatic colorectal carcinoma: a Southern Italy Cooperative Oncology Group phase III trial. Comelia P, Massidda B, Filippelli G et al. Ann Oncol 16: 878-886, 2005
18. Irinotecan plus raltitrexed as first-line treatment in advanced colorectal cancer: a phase II study. J Feliu, A Salud, P Escudero et al; British Journal of Cancer (2004) 90, 1502-1507.
19. Oxaliplatin With Weekly Bolus Fluorouracil and Low-Dose Leucovorin as First-Line Therapy for Patients With Colorectal Cancer. Hochster H, Chachoua A, Speyer J et al, J Clin Oncol 21: 2703-2707, 2003
20. Randomized Multicenter Phase II Trial of Oxaliplatin Plus Irinotecan Verus Raltritrexed as First-Line Treatment in Advanced Colorectal Cancer. Scheithauer W, V. Kornek G, Raderer M et al, J Clin Oncol 20: 165-172, 2002
21. Multicentre Phase II Study of Nordic Fluorouracil and Folinic Acid Bolus Schedule Combined With Oxaliplatin As First-Line Treatment of Metastatic Colorectal Cancer. Sorbye H, Glimelius B, Berglund A et al. J Clin Oncol 22: 31-38
22. Leucovorin and Fluorouracil With or Without Oxaliplatin as First-Line Treatment in Advanced Colorectal Cancer, DeGramont A, Figer A, Seymour M et al, J Clin Oncol 18: 2938-2947, 2000
23. Infusional 5-fluorouracil/folinic acid plus oxaliplatin (FUFOX) versus capecitabine plus oxaliplatin (CAPOX) as first line treatment of metastatic colorectal cancer (MCRC): Results of the safety and efficacy analysis H-T Arkenau, H. Schmoll, S. Kubicka et al, J Clin Oncol 2005: 23: 247s Abst 3507
24. Irinotecan Combined with Bolus 5-Fluorouracil and Folinic Acid for Metastatic Colorectal Cancer: Is This Really a Dangerous Treatment? Idelevich E, Man S, Lavrenkov K et al, J Chemotherapy 16: 487-490, 2004
25. Phase III Study of Weekly High-Dose Infusional Fluorouracil Plus Folinic Acid With or Without Irinotecan in Patients With Metastatic Colorectal Cancer: European Organisation for Research and Treatment of Cancer Gastrointestinal Group Study 40986. Kohne C-H, van Cutsem E, Wils J, Bokemeyer C et al J Clin Oncol 23: 4856-4865, 2005
26. Phase I/II trial of irinotecan plus high-dose 5-fluorouracil (TTD regimen) as first-line chemotherapy in advanced colorectal cancer. Aranda E, Carrato A, Cervantes A et al, Annals of Oncology 15: 559-567, 2004
27. A randomized phase II trial of capecitabine and two different schedules of irinotecan in first-line treatment of metastatic colorectal cancer: efficacy, quality-of-life and toxicity Ann Oncol 16: 282-288, 2005
28. A Randomized Controlled Trial of Fluorouracil Plus Leucovorin, Irinotecan, and Oxaliplatin Combinations in Patients With Previously Untreated Metastatic Colorectal Cancer. Goldberg R, Sargent D, Morton R et al J Clin Oncol 22: 23-30
29. Oxaliplatin plus high-dose folinic acid and 5-fluorouracil i.v. bolus (OXAFAFU) versus irinotecan plus high-dose folinoc acid and 5-fluorouracil i.v. bolus (IRIFAFU) in patients with metastatic colorectal carcinoma: a Southern Italy Cooperative Oncology Group phase III trial. Comelia P, Massidda B, Filippelli G et al. Ann Oncol 16: 878-886, 2005
30. XELOX (Capecitabine Plus Oxaliplatin): Active First line Therapy for Patients with Metastatic Colorectal Cancer. Cassidy J, Tabernero J, Twelves C et al. J Clin Oncol 22(11) 2004: 2084-2091
31. Phase III Study of Weekly High-Dose Infusional Fluorouracil Plus Folinic Acid With or Without Ininotecan in Patients With Metastatic Colorectal Cancer: European Organisation for Research and Treatment of Cancer Gastrointestinal Group Study 40986. Kohne C-H, van Cutsem E, Wils J, Bokemeyer C et al J Clin Oncol 23: 4856-4865, 2005
32. Phase III study of bolus 5-fluorouracil (5-FU)/folinic acid (FA) (Mayo) vs weekly high-dose 24 h 5-FU infusion/FA + oxaliplatin (OXA) (FUFOX) in advanced colorectal cancer (ACRC). Grothey A et al, Proc Am Assoc Clin Oncol 2002 Abst 512
33. FOLFIRI followed by FOLFOX6 or the Reverse Sequence in Advanced Colorectal Cancer: A randomized GERCOR Study. Tournigand C, Andre T, Achille E et al. J Clin Oncol 22: 229-237, 2004
34. OPTIMOX1: A Randomized Study of FOLFOX4 or FOLFOX7 With Oxaliplatic in a Stop-and-Go Fashion in Advanced Colorectal Cancer-A GERCOR study. Tournigand C, Cervantes A, Figer A et al. J Clin Oncol 24: 394-400, 2006
35. FOLFIRI followed by FOLFOX6 or the Reverse Sequence in Advanced Colorectal Cancer: A randomized GERCOR Study. Tournigand C, Andre T, Achille E et al. J Clin Oncol 22: 229-237, 2004
36. FOLFOXIR 1 (folinic acid, 5-fluorouracil, oxaliplatin and irinotecan) vs FOLFIR 1 (folinic acid, 5-fluorouracil, and irinotecan) as first-line treatment in metastatic colorectal cancer (MCC): a multicentre randomised phase III trial from the Hellenic Oncology Research Group (HORG), Souglakos J, Androulakis N, Syrigos K et al. Br J Cancer online advance publ Feb. 28, 2006
37. A randomized phase II trial of capecitabine and two different schedules of irinotecan in first-line treatment of metastatic colorectal cancer: efficacy, quality-of-life and toxicity Ann Oncol 16: 282-288, 2005

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A system for facilitating development of an individualised treatment regimen for a patient having a disease in need of treatment, said system comprising
one or more databases comprising clinical data from a plurality of patients having said disease, said clinical data including event data representative of the presence, absence and/or severity of one or more negative events;
processing means operatively associated with said database and configured for analysing said clinical data to generate an output containing negative event evaluation data;
input means for inputting data into said system, and
output means for outputting data from said system;
wherein said negative event evaluation data facilitates the development of said individualised treatment regimen.

2. The system according to claim 1, wherein said system further comprises a web-based portal for allowing access to and from the Internet.

3. The system according to claim 1, wherein said system further comprises one or more prediction models executable by said processing means for providing a probability that said patient will experience said one or more negative events.

4. The system according to claim 1, wherein said input means is operable for receiving patient data relating to said patient having the disease in need of treatment.

5. The system according to claim 1, wherein said one or more negative events are disease-related.

6. The system according to claim 1, wherein said plurality of patients have undergone at least one treatment option for treatment of said disease.

7. The system according to claim 6, wherein said one or more negative events are treatment-related.

8. The system according to claim 7, wherein said one or more negative events are treatment-related toxicities and said clinical data further comprises efficacy data indicating the efficacy of said treatment option and cumulative toxicity data indicating the sum of said toxicities for each of said plurality of patients.

9. The system according to claim 8, wherein said negative event evaluation data indicates the relationship between treatment option, cumulative toxicity and efficacy.

10. The system according to claim 1, wherein the output containing negative event evaluation data is provided in graphical format.

11. A method for facilitating the development of an individualised treatment regimen for a patient having a disease in need of treatment, said method comprising
assembling clinical data from a plurality of patients having said disease, said clinical data including event data representative of the presence, absence and/or severity of one or more negative events, and
analysing said clinical data to generate an output containing negative event evaluation data;
wherein said negative event evaluation data facilitates the development of said individualised treatment regimen.

12. The method according to claim 11, wherein said method further comprises the step of receiving patient data relating to said patient having a disease in need of treatment.

13. The method according to claim 12, wherein the step of analyzing further comprises executing one or more prediction models to provide a probability that said patient will experience said one or more negative events.

14. The method according to claim 11, wherein said one or more negative events are disease-related.

15. The method according to claim 11, wherein said plurality of patients have undergone at least one treatment option for treatment of said disease.

16. The method according to claim 15, wherein said one or more negative events are treatment-related.

17. The method according to claim 16, wherein said one or more negative events are treatment-related toxicities and said clinical data further comprises efficacy data indicating the efficacy of said treatment option and cumulative toxicity data indicating the sum of said toxicities for each of said plurality of patients.

18. The method according to claim 17, wherein said step of analyzing comprises determining a relationship between treatment option, cumulative toxicity and efficacy.

19. The method according to claim 11, further comprising the step of displaying said output in graphical format.

20. A method for developing a negative event prediction model, said method comprising the steps of:
(i) assembling clinical data representing a patient population having a disease of interest, said clinical data including event data relating to the presence, absence and/or severity of one or more negative events, wherein said patient population includes at least 50 occurrences of said one or more negative events;
(ii) classifying the clinical data into classified data defining a plurality of potential risk factors;
(iii) processing the classified data to identify initial risk factors and selecting secondary data comprising the initial risk factors;
(iv) subjecting the secondary data to a first analysis to generate a general system based on the initial risk factors, and
(v) subjecting the general system to a second analysis to identify primary risk factors and thereby generate a negative event prediction model based on the primary risk factors.

21. The method according to claim 20, wherein said negative event is disease-related.

22. The method according to claim 20, wherein each patient in said patient population has undergone at least one treatment option.

23. The method according to claim 22, wherein said negative event is treatment-related.

24. The method according to claim 22, wherein said treatment option is chemotherapy.

25. The method according to claim 24, wherein said classifying in step (ii) comprises classifying the clinical data by chemotherapy cycle into cycle-classified data defining said plurality of potential risk factors.

26. The method according to claim 24, wherein said one or more negative events are selected from: neutropenia, thrombocytopenia, anaemia, nausea, vomiting, diarrhoea, stomatitis, alopecia, peripheral neuropathy, renal impairment, venous thrombolic events, cardiac toxicity, cognitive dysfunction, clinical depression and skin toxicity.

27. A system for predicting the probability that a patient having a disease will experience a negative event, said system comprising
one or more databases comprising clinical data from a plurality of patients having said disease, said clinical data including event data relating to the presence, absence and/or severity of one or more negative events;
input means for inputting patient data relating to said patient having the disease into said system;
processing means operatively associated with said database and configured for executing a negative event prediction model produced by the method of claim 20 to generate an output containing a negative event prediction value, and
output means for outputting data from said system.

28. An apparatus for facilitating the development of an individualised treatment regimen for a patient having a disease in need of treatment, said apparatus comprising
means for analysing clinical data from a plurality of patients having said disease, said clinical data including event data representative of the presence, absence and/or severity of one or more negative events, and
means for generating an output based on said step of analysing, said output containing negative event evaluation data;
wherein said negative event evaluation data facilitates the development of said individualised treatment regimen.

29. A computer program product comprising a computer readable medium having a computer program recorded thereon which, when executed by a computer processor, cause the processor to execute a method for facilitating the development of an individualised treatment regimen for a patient having a disease in need of treatment, said method comprising
analysing clinical data from a plurality of patients having said disease, said clinical data including event data representative of the presence, absence and/or severity of one or more negative events, and
generating an output based on said step of analysing, said output containing negative event evaluation data;
wherein said negative event evaluation data facilitates the development of said individualised treatment regimen.

30. A computer program product comprising a computer readable medium having a computer program recorded thereon which, when executed by a computer processor, cause the processor to execute a method for developing a negative event prediction model, said method comprising
(i) classifying clinical data into classified data defining a plurality of potential risk factors, wherein said clinical data represents a patient population having a disease of interest, said clinical data including event data relating to the presence, absence and/or severity of one or more negative events, wherein said patient population includes at least 50 occurrences of said one or more negative events;
(ii) processing the classified data to identify initial risk factors and selecting secondary data comprising the initial risk factors;
(iii) subjecting the secondary data to a first analysis to generate a general system based on the initial risk factors, and
(iv) subjecting the general system to a second analysis to identify primary risk factors and thereby generate a negative event prediction model based on the primary risk factors.
